(19) United States
(12) Patent Application Publication
(10) Pub. No.: US 2025/0092919 A1
(43) Pub. Date: Mar. 20, 2025

(54) DAMPER DEVICE

(71) Applicant: AISIN CORPORATION, Kariya, Aichi (JP)

(72) Inventors: Masaru EBATA, Kariya-shi (JP); Hiroaki SUEZAKI, Kariya-shi (JP); Kenichi MUNEDA, Kariya-shi (JP)

(73) Assignee: AISIN CORPORATION, Kariya, Aichi (JP)

(21) Appl. No.: 18/726,649

(22) PCT Filed: Jan. 31, 2023
(86) PCT No.: PCT/JP2023/003067

§ 371 Date: Jul. 3, 2024

(30) Foreign Application Priority Data
Mar. 31, 2022 (JP) 2022-059089

(51) Int. Cl. F16D 7/02; F16D 3/12

(52) U.S. Cl. CPC F16D 7/025; F16D 3/12; F16D 2300/22

(57) ABSTRACT

A damper device includes: a first rotating body that rotates about a rotation axis; a second rotating body that rotates relative to first rotating body; an elastic mechanical unit; a control plate that includes radially extending portion in contact with elastic mechanical unit and a axially extending portion that is at least partially accommodated in one of the first or second rotating body, and is disposed only in one of a first accommodation space or a second accommodation space in axial direction; a first sliding portion that generates a first sliding torque, has a first opening, and is rotatably supported by outer peripheral surface of second rotating body on inner peripheral surface that includes first opening and surrounds first opening; and second sliding portion that generates second sliding torque. In a case where first and rotating body rotate relative to each other, the and second first sliding torque are generated.

### TECHNICAL FIELD

The technology disclosed in the present application relates to a damper device.

### BACKGROUND ART

In a vehicle or the like, a damper device that absorbs torque vibration transmitted from a drive source such as an engine toward a transmission is provided in a torque transmission path between the drive source and the transmission, and the damper device is incorporated into a clutch device, for example.

As for a conventional configuration of a damper device, there is a known technique by which a coil spring is interposed between a disc plate as an input member and a hub as an output member that are rotatable relative to each other, and torque fluctuations are absorbed and attenuated through elastic deformation of the coil spring. Also, there is a technique by which, in addition to the elastic deformation of the coil spring, a sliding torque (hysteresis torque) based on the relative rotation between the disc plate and the hub is generated to further absorb the torque fluctuations.

For example, Patent Literature 1 discloses a damper device that includes: as principal components, a first rotating member (reference numeral 1 in Patent Literature 1) as an input side of power transmission; a second rotating member (reference numeral 2 in Patent Literature 1) as an output side of power transmission; two control plates (reference numerals 31 and 32 in Patent Literature 1); first sliding members (reference numerals 6 and 7 in Patent Literature 1) that generate a first sliding torque; second sliding members (reference numerals 8 and 9 in Patent Literature 1) that generate a second sliding torque higher than the first sliding torque; an elastic member 57 using a cone spring; and the like. Note that the entire contents of Patent Literature 1 are incorporated herein by reference.

### CITATION LIST

### Patent Literature

Patent Literature 1: JP 6471486 B1

### SUMMARY OF INVENTION

### Technical Problems

In the damper device disclosed in Patent Literature 1, however, the two control plates are accommodated between the first rotating member and the second rotating member in the axial direction. Therefore, the number of components is large, and the axial length of the damper device is long, which leads to a problem in mounting the damper device in a vehicle or the like.

Therefore, various embodiments provide damper devices each having a short axial length. Also, damper devices capable of stably generating wide variations of hysteresis torque are provided.

### Solution to Problems

A damper device according to one aspect includes: a first rotating body including at least a first plate that rotates about a rotation axis, and a second plate that is disposed to face the first plate and rotates integrally with the first plate about the rotation axis; a second rotating body that rotates relative to the first rotating body about the rotation axis; an elastic mechanical unit that elastically connects the first rotating body and the second rotating body in a rotation direction; a control plate including a radially extending portion that extends in a radial direction and is in contact with the elastic mechanical unit, and an axially extending portion that extends in an axial direction and is at least partially accommodated in one of the first rotating body or the second rotating body, the control plate being disposed only in one of a first accommodation space between the first plate and the second rotating body or a second accommodation space between the second plate and the second rotating body in the axial direction; a first sliding portion that is disposed between the first rotating body and the control plate, slides with respect to at least one of the first rotating body or the control plate to generate a first sliding torque, has a first opening, and is rotatably supported by an outer peripheral surface of the second rotating body on an inner peripheral surface surrounding the first opening; and a second sliding portion that is disposed between the second rotating body and the control plate, and slides with respect to at least one of the second rotating body or the control plate to generate a second sliding torque. In a case where the first rotating body and the second rotating body rotate relative to each other, the first sliding torque and the second sliding torque are generated.

In this configuration, the single control plate is adopted to reduce the number of components, and thus, a damper device having a short axial length can be provided. Furthermore, it is also possible to increase the assemblability of the first sliding portion with respect to the second rotating body.

Also, in the damper device according to the one aspect, one of the first sliding torque or the second sliding torque is higher than the other one of the first sliding torque or the second sliding torque, and is generated only in a case where the second rotating body rotates relative to the first rotating body in a counterclockwise direction.

With this configuration, the damper device according to the one aspect can constantly generate a low hysteresis torque (the lower torque between the first sliding torque and the second sliding torque) in a case where the first rotating body and the second rotating body rotate relative to each other, and can generate a high hysteresis torque (the higher torque between the first sliding torque and the second sliding torque) in a special case where the first rotating body and the second rotating body rotate relative to each other in a predetermined direction. At this stage, the one of the first sliding torque or the second sliding torque to be generated only in the special case is set to be higher than the other one of the first sliding torque or the second sliding torque, so that the magnitude of the “high hysteresis torque” can be made even higher. In this manner, the damper device according to the one aspect can generate various variations of hysteresis torque. Note that the “high hysteresis torque” mentioned above can be used in a case where relatively large vibration and noise to be generated when the engine of a vehicle (particularly a hybrid vehicle) or the like is started, for example.

Further, in the damper device according to the one aspect, the elastic mechanical unit includes a first elastic member and a pair of sheet members that sandwich and support the first elastic member from both sides, and the radially extending portion is in contact with one of the first elastic member or the pair of sheet members.

In this configuration, the radially extending portion can reliably come into contact with the elastic mechanical unit, and, as a result, the damper device according to the one aspect can efficiently generate the first sliding torque and the second sliding torque.

Also, in the damper device according to the one aspect, the first sliding portion includes a first sliding surface that slides with respect to the first rotating body or the radially extending portion, and a second elastic member that biases the first sliding surface in a direction toward the first rotating body or the radially extending portion.

With this configuration, the damper device according to the one aspect can reliably and efficiently generate the first sliding torque.

Also, in the damper device according to the one aspect, the second sliding portion includes a second sliding surface that slides with respect to the second rotating body or the radially extending portion, and a third elastic member that biases the second sliding surface in a direction toward the second rotating body or the radially extending portion.

With this configuration, the damper device according to the one aspect can reliably and efficiently generate the second sliding torque.

Further, in the damper device according to the one aspect, the first sliding portion and the second sliding portion are formed integrally with the control plate, and function as part of the control plate, and the radially extending portion slides directly on the first rotating body, and slides directly on the second rotating body.

With this configuration, the damper device according to the one aspect can further reduce the number of components by integrating the control plate, the first sliding portion, and the second sliding portion.

Further, the damper device according to the one aspect includes a thrust member including at least one of a first surface that slides with respect to the first rotating body or a second surface that slides with respect to the second rotating body, in a space on a different side from a space in which the control plate is disposed in the first accommodation space or the second accommodation space.

With this configuration, the damper device according to the one aspect can further generate hysteresis torque additionally, on the basis of the first surface and the second surface.

Also, in the damper device according to the one aspect, the thrust member includes a fourth elastic member that biases the second surface in a direction toward the second rotating body.

With this configuration, the damper device according to the one aspect can reliably and efficiently generate the additional hysteresis torque mentioned above.

Further, in the damper device according to the one aspect, the thrust member has a second opening, and is rotatably supported by the outer peripheral surface of the second rotating body on the inner peripheral surface surrounding the second opening, and a gap formed between the inner peripheral surface surrounding one of the first opening or the second opening located on the transmission side and the outer peripheral surface of the second rotating body is narrower than a gap formed between the inner peripheral surface surrounding the other one of the first opening or the second opening and the outer peripheral surface of the second rotating body.

With this configuration, in the damper device according to the one aspect, the angle at which the second rotating body is inclined with respect to the drive shaft, which is the angle at which the first sliding portion supported by the second rotating body is inclined or the angle at which the thrust member supported by the second rotating body is inclined, can be restricted to a small angle. Accordingly, it is possible to lower the possibility that the sliding of the first sliding portion with respect to the control plate or the sliding of the thrust member with respect to the second rotating body changes compared with the originally intended sliding.

Further, the damper device according to the one aspect includes a thrust member including at least one of a first surface that slides with respect to the first rotating body or a second surface that slides with respect to the second rotating body, in a space on a different side from a space in which the control plate is disposed in the first accommodation space or the second accommodation space. One of the first sliding portion or the thrust member, whichever is located on the transmission side, is formed as a bush.

With this configuration, the damper device according to the one aspect can easily and effectively prevent a situation in which the second rotating body is inclined with respect to the drive shaft Z.

Also, in the damper device according to the one aspect, at a position facing the control plate, the first sliding portion includes: a first vertex portion in contact with the control plate; a first inclined surface that is connected to the first vertex portion, extends in a direction away from the rotation axis of the first sliding portion, and is inclined in a direction away from the control plate; and a second inclined surface that is connected to the first vertex portion, extends in a direction toward the rotation axis, and is inclined in the direction away from the control plate.

With this configuration, in the damper device according to the one aspect, even in a case where the second rotating body is inclined with respect to the drive shaft, the first sliding portion comes into contact with the control plate at the first vertex portion and slides thereon. Accordingly, it is possible to reduce the change in the area of the portion of contact between the first sliding surface portion and the control plate. Thus, the damper device according to the one aspect can prevent the magnitude of the first sliding torque from changing.

Further, in the damper device according to the one aspect, at a position facing the second rotating body, the thrust member includes: a second vertex portion in contact with the second rotating body; a third inclined surface that is connected to the second vertex portion, extends in a direction away from the rotation axis of the thrust member, and is inclined in a direction away from the second rotating body; and a fourth inclined surface that is connected to the second vertex portion, extends in a direction toward the rotation axis of the thrust member, and is inclined in the direction away from the second rotating body.

With this configuration, in the damper device according to the one aspect, even in a case where the second rotating body is inclined with respect to the drive shaft, the thrust member is still in contact with the surface of the second rotating body facing the thrust member at the second vertex portion, and slides thereon. Accordingly, the area of the portion of contact between the thrust member and the second rotating body does not change significantly. Thus, the damper device according to the one aspect can prevent the magnitude of the third sliding torque from changing.

Also, in the damper device according to the one aspect, at a position facing the second rotating body, the second sliding portion includes: a third vertex portion in contact with the second rotating body; a fifth inclined surface that is connected to the third vertex portion, extends in a direction away from the rotation axis of the second sliding portion, and is inclined in a direction away from the second rotating body; and a sixth inclined surface that is connected to the third vertex portion, extends in a direction toward the rotation axis of the second sliding portion, and is inclined in the direction away from the second rotating body.

With this configuration, in the damper device according to the one aspect, even in a case where the second rotating body is inclined with respect to the drive shaft, the second sliding portion is still in contact with the surface of the second rotating body facing the second sliding portion at the third vertex portion, and slides thereon. Accordingly, the area of the portion of contact between the second sliding portion and the second rotating body does not greatly change. Thus, the damper device according to the one aspect can prevent the magnitude of the third sliding torque from changing. According to the various embodiments, damper devices each having a short axial length can be provided. Also, damper devices capable of stably generating wide variations of hysteresis torque can be provided.

### BRIEF DESCRIPTION OF DRAWINGS

FIG. 1 is a schematic top view schematically illustrating the configuration of a damper device according to an embodiment.

FIG. 2 is a schematic top view schematically illustrating a configuration in which some components are omitted from the damper device illustrated in FIG. 1.

FIG. 3A is a schematic cross-sectional view schematically illustrating the configuration of the damper device illustrated in FIG. 1, as viewed from the line X-X.

FIG. 3B is a schematic enlarged cross-sectional view schematically illustrating part of the damper device illustrated in FIG. 3A.

FIG. 3C is a schematic enlarged cross-sectional view schematically illustrating part of the configuration of the damper device illustrated in FIG. 3B.

FIG. 4 is a schematic perspective view illustrating the configuration of the damper device according to the embodiment, divided into the respective components.

FIG. 5 is a schematic enlarged perspective view illustrating a control plate of the damper device according to the embodiment.

FIG. 6 is a schematic enlarged view schematically illustrating only the region surrounded by a dotted line shown in FIG. 2 in the damper device according to the embodiment.

FIG. 7A is a schematic top view schematically illustrating a state in which a first rotating body and a second rotating body do not rotate relative to each other in the damper device according to the embodiment.

FIG. 7B is a schematic top view schematically illustrating a state in which the second rotating body rotates relative to the first rotating body at a twisting angle θ1° on the positive side in the damper device according to the embodiment.

FIG. 7C is a schematic top view schematically illustrating a state in which the second rotating body rotates relative to the first rotating body at a twisting angle θ2° on the positive side in the damper device according to the embodiment.

FIG. 7D is a schematic top view schematically illustrating a state in which the second rotating body rotates relative to the first rotating body at a twisting angle θ3° on the negative side in the damper device according to the embodiment.

FIG. 7E is a schematic top view schematically illustrating a state in which the second rotating body rotates relative to the first rotating body at a twisting angle θ4° on the negative side in the damper device according to the embodiment.

FIG. 7F is a schematic top view schematically illustrating a state in the middle of canceling of the relative rotation of the second rotating body with respect to the first rotating body from the state illustrated in FIG. 7E, in the damper device according to the embodiment.

FIG. 8 is a schematic characteristics diagram schematically illustrating the torsion characteristics in the damper device according to the embodiment.

FIG. 9 is a schematic cross-sectional view schematically illustrating the configuration of a damper device according to a second embodiment.

FIG. 10 is a schematic cross-sectional view schematically illustrating the configuration of a damper device according to a third embodiment.

FIG. 11 is a schematic cross-sectional view schematically illustrating the configuration of a damper device according to a fourth embodiment.

FIG. 12 is a schematic cross-sectional view schematically illustrating the configuration of a damper device according to a fifth embodiment.

FIG. 13 is a schematic cross-sectional view schematically illustrating the configuration of a damper device according to a sixth embodiment.

FIG. 14 is a schematic enlarged view schematically illustrating the relationship between a disc plate and a control plate in the damper device according to the sixth embodiment.

FIG. 15 is a schematic cross-sectional view schematically illustrating the configuration of a damper device according to a seventh embodiment.

FIG. 16 is a schematic cross-sectional view schematically illustrating the configuration of a damper device according to an eighth embodiment.

FIG. 17 is a schematic cross-sectional view schematically illustrating the configuration of a damper device according to a ninth embodiment.

FIG. 18 is a schematic cross-sectional view schematically illustrating the configuration of a damper device according to a tenth embodiment.

FIG. 19 is a schematic cross-sectional view schematically illustrating the configuration of a damper device according to an embodiment.

FIG. 20 is a schematic enlarged cross-sectional view schematically illustrating part of the configuration of the damper device illustrated in FIG. 19.

FIG. 21 is a schematic cross-sectional view schematically illustrating the configuration of a damper device according to an embodiment.

FIG. 22 is a schematic top view schematically illustrating a state in which a first rotating body and a second rotating body do not rotate relative to each other in the damper device according to the embodiment.

FIG. 23 is a schematic characteristics diagram schematically illustrating the torsion characteristics in the damper device according to an embodiment.

### DESCRIPTION OF EMBODIMENTS

In the description below, various embodiments will be explained with reference to the accompanying drawings. Note that components common in the drawings are denoted by the same reference numerals. Also, it should be noted that the components illustrated in a certain drawing may be omitted in another drawing, for ease of explanation. Furthermore, it should be noted that the accompanying drawings are not necessarily to scale.

### 1. Configuration of a Damper Device

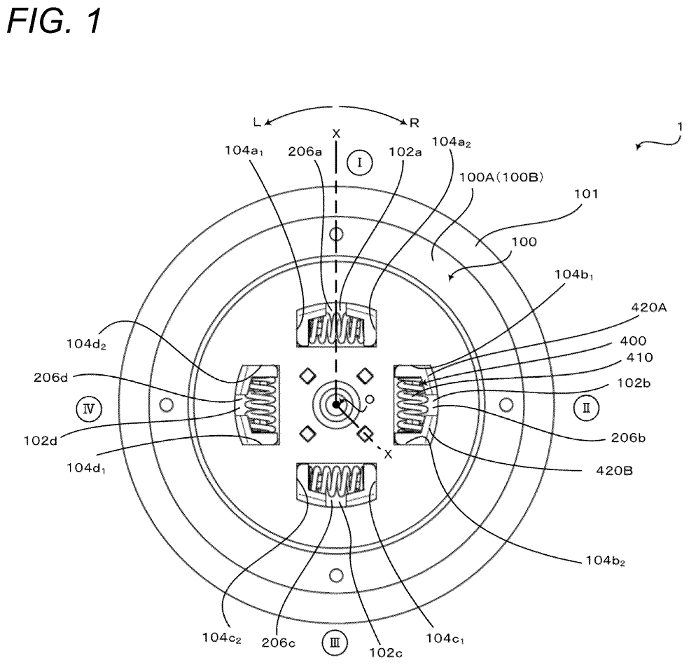

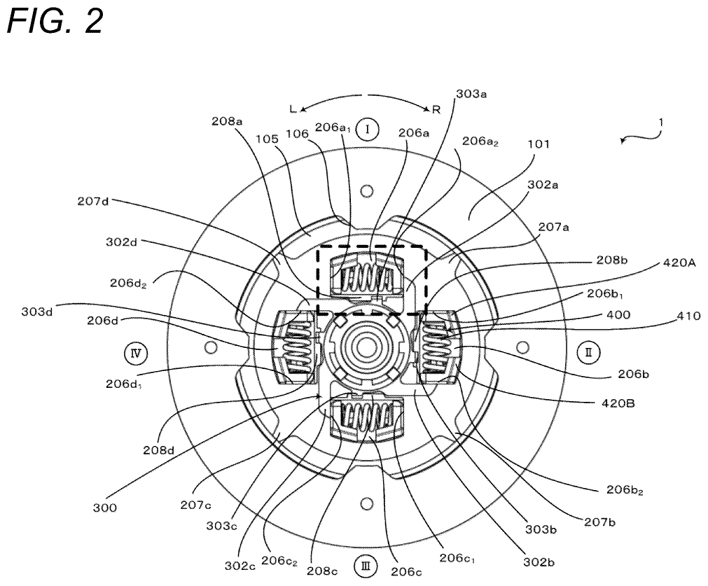

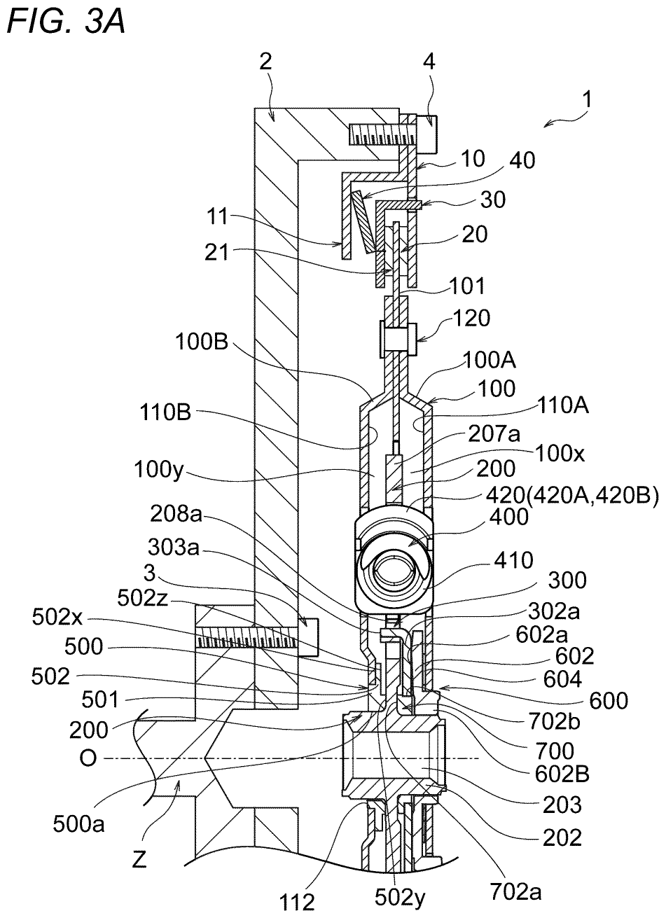

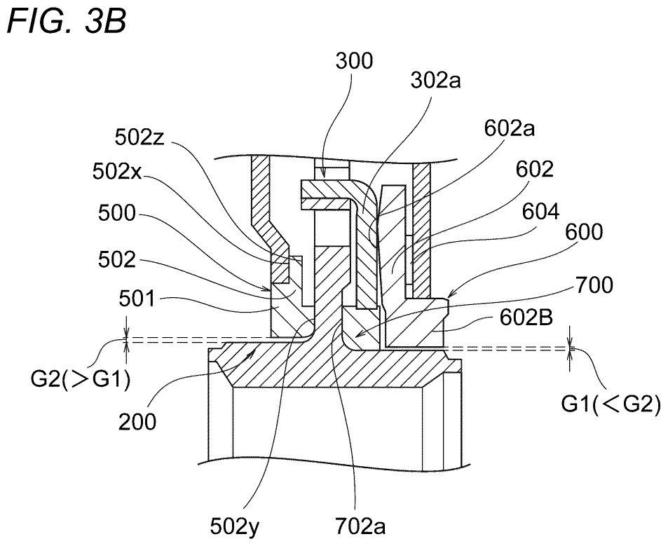

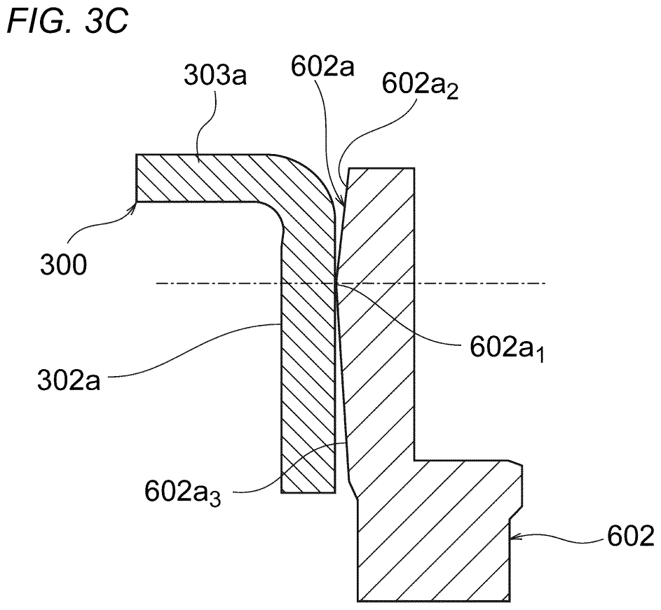

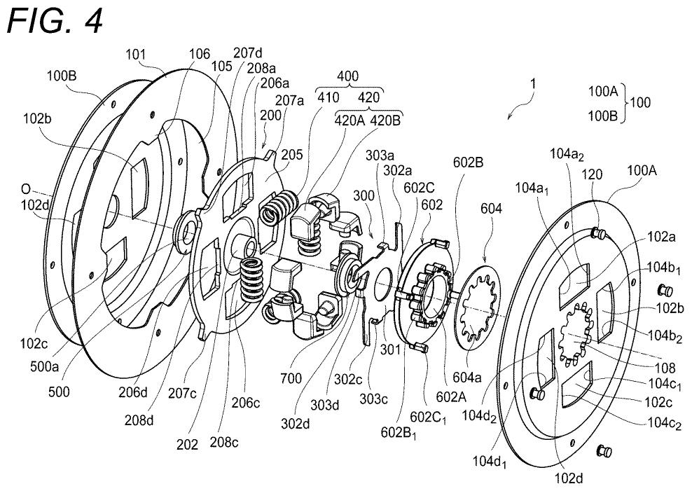

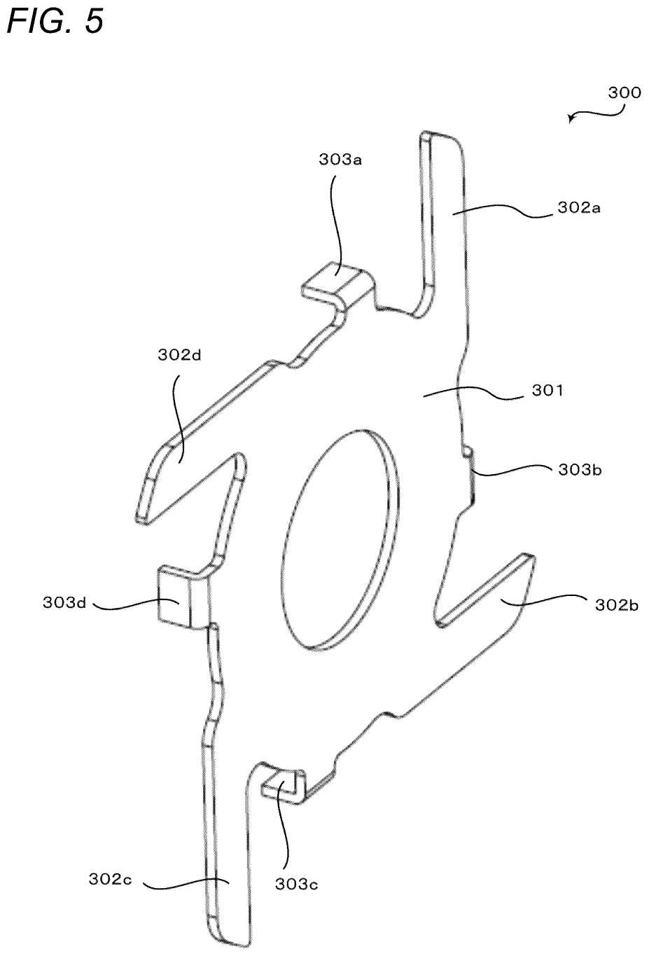

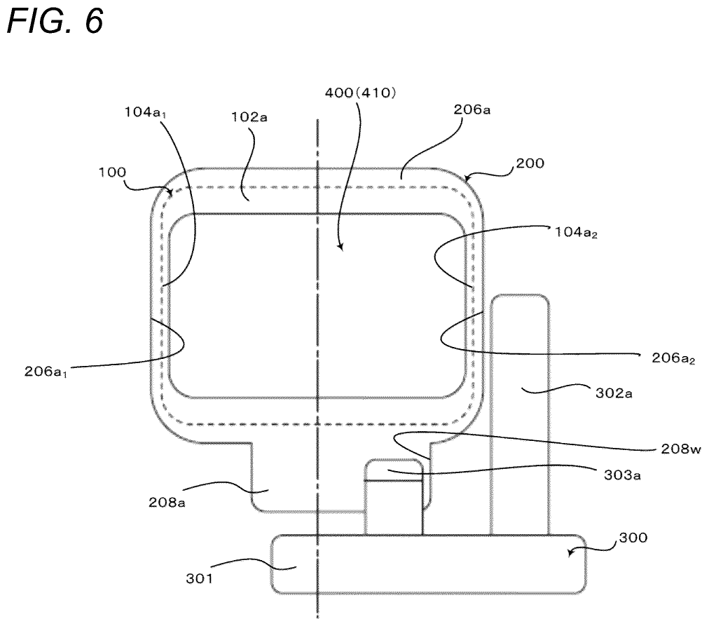

An overview of the configuration of an entire damper device according to an embodiment is now described with reference to FIGS. 1 to 6. FIG. 1 is a schematic top view schematically illustrating the configuration of a damper device 1 according to the embodiment. FIG. 2 is a schematic top view schematically illustrating a configuration in which some components are omitted from the damper device 1 illustrated in FIG. 1. FIG. 3A is a schematic cross-sectional view schematically illustrating the configuration of the damper device 1 illustrated in FIG. 1, as viewed from the line X-X. FIG. 3B is a schematic enlarged cross-sectional view schematically illustrating part of the damper device 1 illustrated in FIG. 3A. FIG. 3C is a schematic enlarged cross-sectional view schematically illustrating part of the configuration of the damper device 1 illustrated in FIG. 3B. FIG. 4 is a schematic perspective view illustrating the configuration of the damper device 1 according to the embodiment, divided into the respective components. FIG. 5 is a schematic enlarged perspective view illustrating a control plate 300 of the damper device 1 according to the embodiment. FIG. 6 is a schematic enlarged view schematically illustrating only the region surrounded by a dotted line shown in FIG. 2 in the damper device 1 according to the embodiment. Note that, in FIG. 6, for the sake of convenience, a pair of sheet members 420 in an elastic mechanical unit 400 described later are not shown, and the contact relationship between the respective components (the elastic mechanical unit 400 and a disc plate 100, and the elastic mechanical unit 400 and a hub 200, for example) is not accurately illustrated.

The damper device 1 according to the embodiment is disposed in a power transmission path for a drive source (not shown) such as an engine or a motor and a transmission or the like, and power from the drive source is transmitted (output), via a flywheel 2, to the transmission or the like (see FIG. 3A).

The damper device 1 absorbs and attenuates torque vibration. As illustrated in FIGS. 1 to 5, the damper device 1 mainly includes the disc plate 100 as a first rotating body to which power is transmitted from the flywheel 2, the hub 200 as a second rotating body, the control plate 300, elastic mechanical units 400, a thrust member 500, a first sliding portion 600, and a second sliding portion 700. Note that, in the present specification, the axial direction means a direction extending parallel to a rotation axis O, the radial direction means a direction orthogonal to the rotation axis O, and the circumferential direction means a direction circulating around the rotation axis O.

Note that the flywheel 2 is an annular plate member secured to a drive shaft Z connected to the drive source by a bolt 3.

Further, as illustrated in FIG. 3A, power transmitted from the drive shaft Z to the flywheel 2 is transmitted to the disc plate 100 via a cover plate 10 that rotates integrally with the flywheel 2 and is secured to the flywheel 2 by a bolt 4, and a first friction material 20. Note that a pressure plate 30 is secured to the cover plate 10, and the cover plate 10 and the pressure plate 30 are designed to rotate integrally with each other. A support plate 11 is further secured to the flywheel 2 together with the cover plate 10 by the bolt 4, and the support plate 11 supports a disc spring 40. The disc spring 40 biases the pressure plate 30 so as to push the pressure plate 30 against a lining plate 101 of the disc plate 100 described later via a second friction material 21, and, together with the cover plate 10, transmits power transmitted to the flywheel 2, to the disc plate 100 (lining plate 101).

Note that the support plate 11, the pressure plate 30, and the disc spring 40 can function as a limiter that generates slip (to cut off the power transmission from the cover plate 10 and the pressure plate 30 to the disc plate 100) in a case where the damper device 1 cannot absorb torque fluctuations in a twisting direction. Note that the limiter may be a combination of conventionally known structures.

### 1-1. Disc Plate 100

In the damper device 1, power from a drive source such as an engine or a motor is transmitted via the flywheel 2 to the disc plate 100 as the first rotating body disposed on the most upstream side in the power transmission path, as described above. The disc plate 100 is formed with a metal material, for example, and is disposed to be rotatable around the rotation axis O, with the later-described hub 200 or the like as the second rotating body being interposed, as illustrated in FIGS. 1 to 4. The disc plate 100 includes a first plate 100A and a second plate 100B as a pair of substantially disc-shaped plate members disposed on both sides in the axial direction of the hub 200 (the second plate 100B is disposed to face the first plate 100A in the axial direction). As illustrated in FIGS. 3A and 4, the first plate 100A and the second plate 100B have symmetrical shapes in the axial direction, and are joined to each other by a plurality of rivets 120 in the vicinity of the outer periphery so as to be integrally rotatable, with the substantially annular lining plate 101 being interposed therebetween, the lining plate 101 being capable of adjusting the positions of both plates in the axial direction as appropriate.

When power from the drive source such as an engine or a motor is transmitted from the cover plate 10 and the pressure plate 30 to the lining plate 101 via the first friction material 20 and the second friction material 21 provided on the lining plate 101, the power is transmitted from the lining plate 101 to the first plate 100A and the second plate 100B in the vicinities of the rivets 120.

As illustrated in FIGS. 1 and 2, the first plate 100A and the second plate 100B in cooperation with each other have a shape bulging in the axial direction so as to form accommodation regions (four accommodation regions are shown in the example illustrated in FIG. 1) for accommodating the later-described elastic mechanical units 400 associated with respective regions I to IV. Each accommodation region extends in a substantially linear shape or a substantially arc shape along the circumferential direction of the disc plate 100, so as to accommodate a first elastic member 410 and a pair of sheet members 420 (a sheet member 420A and a sheet member 420B) in the elastic mechanical unit 400 extending along the circumferential direction of the disc plate 100. Note that the regions I to IV represent the respective four regions each having a fan-like shape with approximately 90 degrees as illustrated in FIG. 1 when the damper device 1 is viewed from above.

More specifically, referring to FIG. 1, the first plate 100A and the second plate 100B form a first accommodation region 102a, a second accommodation region 102b, a third accommodation region 102c, and a fourth accommodation region 102d that are associated with the regions I to IV and each extend in the circumferential direction. Note that, in the hub 200, window holes 206a, 206b, 206c, and 206d corresponding to the first accommodation region 102a, the second accommodation region 102b, the third accommodation region 102c, and the fourth accommodation region 102d are formed in the respective region, as described later.

When attention is paid to the region IV, the first plate 100A and the second plate 100B include, as sidewalls surrounding the fourth accommodation region 102d, one end face (fourth one end face) 104d₁ and the other end face (fourth other end face) 104d₂ that faces the one end face 104d₁, as illustrated in FIG. 1. As an example, the fourth one end face 104d₁ and the fourth other end face 104d₂ extend in the axial direction of the disc plate 100.

Likewise, when attention is paid to the region I, the first plate 100A and the second plate 100B include, as sidewalls surrounding the first accommodation region 102a, one end face (first one end face) 104a₁ and the other end face (first other end face) 104a₂ facing the one end face 104a₁. When attention is paid to the region II, the first plate 100A and the second plate 100B include, as sidewalls surrounding the second accommodation region 102b, one end face (second one end face) 104b₁ and the other end face (second other end face) 104b₂ facing the one end face 104b₁. When attention is paid to the region III, the first plate 100A and the second plate 100B include, as sidewalls surrounding the third accommodation region 102c, one end face (third one end face) 104c₁ and the other end face (third other end face) 104c₂ facing the one end face 104c₁. These sidewalls are in contact (engaged) with the elastic mechanical units 400 described later.

As illustrated in FIG. 3A, the lining plate 101 in the disc plate 100 is disposed at the same axial position as the hub 200 (on a straight line in the radial direction). Therefore, as illustrated in FIGS. 2 and 4, cutout portions 105 that allow movement (relative rotation) of the hub 200 in the circumferential direction are formed in the respective regions I to IV in the lining plate 101. Further, the outer edges of the cutout portions 105 function as restricting portions 106 that restrict excessive relative rotation of the hub 200.

Furthermore, the inner surface 110A of the first plate 100A can support a second elastic member 604 that can form part of the first sliding portion 600 described later. Note that, as described later, in a case where the first sliding portion 600 is disposed between the second plate 100B and the hub 200, the inner surface 110B of the second plate 100B can support the second elastic member 604.

Other than the above, details of the first plate 100A and the second plate 100B will be described later as appropriate.

### 1-2. Hub 200

The hub 200 as the second rotating body functions as an output member in the damper device 1, is formed with a metal material, for example, has a substantially disc-like shape as a whole, and is interposed between the first plate 100A and the second plate 100B so as to be relatively rotatable about the rotation axis O with respect to the disc plate 100 (the first plate 100A and the second plate 100B). Also, as illustrated in FIGS. 3A and 4, the hub 200 can be splined to an input shaft (not illustrated) of a transmission (transmission) by inserting the input shaft into a through hole 203 formed in a cylindrical portion 202 that has a substantially cylindrical shape. Further, the hub 200 has a disc portion 205 extending radially outward from the cylindrical portion 202.

In the disc portion 205, the window holes 206a, 206b, 206c, and 206d corresponding to the first accommodation region 102a, the second accommodation region 102b, the third accommodation region 102c, and the fourth accommodation region 102d are formed at regular intervals, as described above. These window holes 206a to 206d formed in the hub 200 correspond to the elastic mechanical units 400 described later. That is, the elastic mechanical units 400 are accommodated in the respective window holes 206a to 206d.

Further, as illustrated in FIG. 2, associated with the region I, the window hole 206a includes an engaging portion (an engaging portion on a first one end side) 206a₁ on one end side and an engaging portion (an engaging portion on a first other end side) 206a₂ on the other end side facing the engaging portion 206a₁, and is in contact (engaged) with the elastic mechanical unit 400. Likewise, associated with the region II, the window hole 206b associated with the region II includes an engaging portion (an engaging portion on a second one end side) 206b₁ on one end side and an engaging portion (an engaging portion on a second other end side) 206b₂ on the other end side facing the engaging portion 206b₁, and is in contact (engaged) with the elastic mechanical unit 400. Also, associated with the region III, the window hole 206c includes an engaging portion (an engaging portion on a third one end side) 206c₁ on one end side and an engaging portion (an engaging portion on a third other end side) 206c₂ on the other end side facing the engaging portion 206c₁, and is in contact (engaged) with the elastic mechanical unit 400. Further, associated with the region IV, the window hole 206d includes an engaging portion (an engaging portion on a fourth one end side) 206d₁ on one end side and an engaging portion (an engaging portion on a fourth other end side) 206d₂ on the other end side facing the engaging portion 206d₁, and is in contact (engaged) with the elastic mechanical unit 400.

Note that each of the window holes 206a to 206d “being in contact with the elastic mechanical unit 400” means each window hole being in contact with the first elastic member 410 or the pair of sheet members 420 described later.

Protrusions 207a, 207b, 207c, and 207d associated with the regions I to IV are formed at the radial end of the disc portion 205. The protrusions 207a to 207d are accommodated in the cutout portions 105 formed in the lining plate 101 so that the hub 200 can rotate relative to the disc plate 100. Further, when the hub 200 relatively rotates at a predetermined twisting angle, the protrusions 207a to 207d come into contact with the restricting portions 106, which are outer edge portions of the cutout portions 105, and thus, excessive relative rotation of the hub 200 is restricted.

Further, as illustrated in FIGS. 2 to 4, grooves 208a, 208b, 208c, and 208d that accommodate axially extending portions 303a to 303d of the control plate 300 described later are formed on the radially inner side of the window holes 206a, 206b, 206c, and 206d. Note that, in the damper device 1 of the embodiment, the respective grooves 208a to 208d are provided continuously (integrally) in the respective window holes 206a to 206d. However, the grooves 208a to 208d are not limited to this, and may be provided in any portions of the disc portion 205.

### 1-3. Control Plate 300

The control plate 300 is formed with a metal material such as spring steel, for example, and has a substantially annular shape as a whole. In the damper device 1 according to one aspect, only one control plate 300 is provided, and is disposed only in either a first accommodation space 100x between the first plate 100A and the hub 200 or a second accommodation space 100y between the second plate 100B and the hub 200 in the axial direction. FIG. 3A illustrates an example in which the control plate 300 is disposed in the first accommodation space 100x.

As illustrated in FIGS. 2 to 5, the control plate 300 mainly includes: a principal portion 301 formed in a substantially annular shape; radially extending portions 302 that extend in the radial direction from the principal portion 301 and are in contact with the elastic mechanical units 400 described later; and axially extending portions 303 that extend in the axial direction and are at least partially accommodated in the hub 200 (a case where the axially extending portions 303 are partially accommodated in the first rotating body 100 will be described later). The radially extending portions 302 include a radially extending portion 302a in the region I, a radially extending portion 302b in the region II, a radially extending portion 302c in the region III, and a radially extending portion 302d in the region IV, so as to correspond to the respective regions I to IV described above. Likewise, the axially extending portions 303 include an axially extending portion 303a in the region I, an axially extending portion 303b in the region II, an axially extending portion 303c in the region III, and an axially extending portion 303d in the region IV, so as to correspond to the respective regions I to IV described above.

As illustrated in FIG. 2 and others, the radially extending portions 302a to 302d are associated with the regions I to IV. The radially extending portion 302a is disposed so as to be in contact with the first elastic member 410 (or one of the sheet member 420A and the sheet member 420B constituting the pair of sheet members 420) accommodated in the first accommodation region 102a (the window hole 206a), the radially extending portion 302b is disposed so as to be in contact with the first elastic member 410 (or one of the sheet member 420A and the sheet member 420B constituting the pair of sheet members 420) accommodated in the second accommodation region 102b (the window hole 206b), the radially extending portion 302c is disposed so as to be in contact with the first elastic member 410 (or one of the sheet member 420A and the sheet member 420B constituting the pair of sheet members 420) accommodated in the third accommodation region 102c (the window hole 206c), and the radially extending portion 302d is disposed so as to be in contact with the first elastic member 410 (one of the sheet member 420A and the sheet member 420B constituting the pair of sheet members 420) accommodated in the fourth accommodation region 102d (the window hole 206d).

The length of the radially extending portions 302a to 302d extending in the radial direction is not limited to any particular length, as long as a sufficient contact area can be secured with respect to each elastic mechanical unit 400 (either a first elastic body 400 or one of the sheet member 420A and the sheet member 420B constituting the pair of sheet members 420).

Note that, in the description below, a case where the radially extending portions 302 include a total of four radially extending portions 302a, 302b, 302c, and 302d associated with the regions I to IV, respectively, will be explained as the embodiment. However, the radially extending portions 302 may include only one to three radially extending portions out of the radially extending portions 302a, 302b, 302c, and 302d. As described above, an embodiment in which the radially extending portions 302 includes only any one to three radially extending portions can be easily understood by those skilled in the art from reading the following description assuming that there are no remaining radially extending portions. For example, an embodiment in which the radially extending portions 302 include only the radially extending portions 302a and 302c can be easily understood by those skilled in the art from reading the following description assuming that the remaining radially extending portions 302b and 302d are not present.

In a case where the control plate 300 is disposed in the first accommodation space 100x as illustrated in FIG. 3A, the radially extending portions 302a to 302d face both the first plate 100A and the hub 200 in the axial direction. Therefore, the radially extending portions 302a to 302d include surfaces that slide into contact with the later-described first sliding portion 600 disposed between the first plate 100A and the control plate 300, to generate a first sliding torque.

As illustrated in FIGS. 2 to 6, the axially extending portions 303a to 303d are associated with the regions I to IV, and are arranged so that the axially extending portion 303a is accommodated in the groove 208a formed on the radially inner side of the window hole 206a, the axially extending portion 303b is accommodated in the groove 208b formed on the radially inner side of the window hole 206b, the axially extending portion 303c is accommodated in the groove 208c formed on the radially inner side of the window hole 206c, and the axially extending portion 303d is accommodated in the groove 208d formed on the radially inner side of the window hole 206d.

As illustrated in FIG. 6, the axially extending portion 303a is accommodated at a position close to a wall portion 208w defining the groove 208a (a position at least deviating from the center position of the groove 208a). The axially extending portion 303b, the axially extending portion 303c, and the axially extending portion 303d are also accommodated in the corresponding grooves 208b, 208c, and 208d at the same positions as those of the axially extending portion 303a.

Here, the axially extending portions 303a to 303d are not engaged with or fitted to the hub 200 by some means in the corresponding grooves 208a to 208d, but are designed so that the hub 200 and the control plate 300 can rotate integrally only in a predetermined case. Accordingly, the control plate 300 and the hub 200 do not always rotate integrally.

Here, the “predetermined case” mentioned above is described. For example, when the hub 200 relatively rotates by a predetermined twisting angle or more in a predetermined direction (for example, an L direction (counterclockwise direction) in FIGS. 1 and 2) with respect to the disc plate 100, the axially extending portions 303a to 303d each come into contact with the wall portion 208w defining the groove 208a. As a result, only in a case where the hub 200 rotates relative to the disc plate 100 by the predetermined twisting angle or more in the predetermined direction (for example, the L direction (counterclockwise direction) in FIGS. 1 and 2), the control plate 300 rotates relative to the disc plate 100 in the predetermined direction (the L direction in FIGS. 1 and 2), integrally with the hub 200. Thus, the radial extension 302a can slide into contact with a sliding surface (first sliding surface) 602a of the first sliding portion 600 described later, to generate the first sliding torque. Likewise, the radially extending portions 302b to 302d can also slide into contact with the first sliding surface 602a of the first sliding portion 600, to generate the first sliding torque. Note that a mechanism by which the control plate 300 and the hub 200 can rotate integrally will be described later in detail.

On the other hand, in a case other than the above case where the control plate 300 rotates integrally with the hub 200, the hub 200 basically rotates relative to the control plate 300. In this case, the later-described second sliding portion 700 disposed between the hub 200 and the control plate 300 can slide with respect to the hub 200 or slide with respect to the control plate 300, to generate a second sliding torque.

To increase (or decrease) the magnitude of the first sliding torque, it is preferable to separately apply a generally known friction material or apply predetermined surface treatment to the surfaces of the radially extending portions 302a to 302d in sliding contact with the first sliding surface 602a of the first sliding portion 600. As a result, the magnitude of the first sliding torque can be adjusted to a desired magnitude.

Further, in a case where the second sliding portion 700 described later slides with respect to the control plate 300 to generate the second sliding torque, it is preferable to separately apply a generally known friction material or apply predetermined surface treatment to the surfaces of the radially extending portions 302a to 302d in sliding contact with the second sliding portion 700 (the surfaces opposite to the surfaces in sliding contact with the first sliding surface 602a of the first sliding portion 600 in the axial direction), to increase (or decrease) the magnitude of the second sliding torque.

Meanwhile, in the damper device 1 according to the embodiment illustrated in FIGS. 1 to 6, the first sliding torque to be generated only in the above-described “predetermined case” is set, as appropriate, to a higher torque than the second sliding torque through the above-described friction material, surface treatment, or the like.

### 1-4. Elastic Mechanical Units 400

As illustrated in FIGS. 1 to 4 and 6, in each of the regions I to IV, the elastic mechanical unit 400 is formed mainly with the first elastic member 410 and the pair of sheet members 420 (the sheet member 420A and the sheet member 420B) supporting the first elastic member 410 by sandwiching the first elastic member 410 from both sides. However, the pair of sheet members 420 may be excluded. Note that, as illustrated in FIGS. 1 to 4, in each of the regions I to IV, one first elastic member 410 may be disposed, but two or more first elastic members 410 may be disposed in series.

As an example, a generally known coil spring can be used as the first elastic member 410. Also, as long as the sheet member 420A and the sheet member 420B form a structure capable of sandwiching and supporting the first elastic member 410 from both sides, their forms, structures, and the like are not limited to any particular ones, and, for example, known ones can be used.

In the embodiment illustrated in FIGS. 1 to 4, as an example, four accommodation regions that are the first accommodation region 102a, the second accommodation region 102b, the third accommodation region 102c, and the fourth accommodation region 102d (for these regions, the window holes 206a, 206b, 206c, and 206d are formed in the hub 200 as described above) are formed in the disc plate 100. Thus, one first elastic member 410 and one pair of sheet members 420 (the sheet member 420A and the sheet member 420B) are accommodated in each of the four accommodation regions, or are associated with each corresponding one of the regions I to IV.

Here, when attention is paid to the region I, as illustrated in FIGS. 1 and 2, the sheet member 420A is engaged with the first one end face 104a₁ of the disc plate 100 (the first plate 100A and the second plate 100B) and the engaging portion 206a₁ on the first one end side in the hub 200. Also, the sheet member 420B is engaged with the first other end face 104a₂ of the disc plate 100 (the first plate 100A and the second plate 100B) and the engaging portion 206a₂ on the first other end side in the hub 200. In each of the regions II to IV, the sheet member 420A and the sheet member 420B constituting the pair of sheet members 420 are also engaged with the disc plate 100 and the hub 200.

Note that, as described above, each of the radial extensions 302a to 302d of the control plate 300 is formed so as to be in contact with the first elastic member 410 (or one of the sheet member 420A and the sheet member 420B constituting the pair of sheet members 420) in each of the regions I to IV, as illustrated in FIG. 2 and others.

In the above configuration, the elastic mechanical units 400 can elastically connect the disc plate 100 and the hub 200 in the rotation direction. That is, when power from the drive source such as an engine or a motor is transmitted to the disc plate 100, the elastic mechanical units 400, and the hub 200 in this order, and the disc plate 100 and the hub 200 then rotate relative to each other, the first elastic members 410 of the elastic mechanical units 400 are compressed and deformed to absorb torque fluctuations.

### 1-5. Thrust Member 500

The thrust member 500 is disposed in a space on a side different from the space in which the control plate 300 is disposed, between the first accommodation space 100x and the second accommodation space 100y described above. That is, in the embodiment according to FIGS. 1 to 6, the control plate 300 is disposed in the first accommodation space 100x. Therefore, the thrust member 500 is disposed not in the first accommodation space 100x but in the second accommodation space 100y. Note that, in a case where the control plate 300 is disposed in the second accommodation space 100y, the thrust member 500 is disposed in the first accommodation space 100x.

In the embodiment in which the thrust member 500 is disposed in the second accommodation space 100y, the thrust member 500 is located between the second plate 100B and the hub 200 as illustrated in FIG. 3A. The thrust member 500 can include an opening (second opening) 500a penetrating the cylindrical portion 202 of the hub 200. As a result, the thrust member 500 is rotatably supported by the outer peripheral surface of the cylindrical portion 202 of the hub 200 on the inner peripheral surface surrounding the opening 500a. The thrust member 500 is formed with a resin material, for example, and includes a substantially cylindrical fitting portion 501, and a principal portion 502 that is substantially annular or substantially cylindrical as a whole.

As illustrated in FIG. 3A, as an example, the fitting portion 501 corresponds to a fitting hole 112 formed in the second plate 100B, and can be fitted into (engaged with) the second fitting hole 112. As a result, the thrust member 500 is integrated with the second plate 100B (disc plate 100), and rotates integrally with the disc plate 100 about the rotation axis O. Note that the fitting portion 501 may not be fitted into the fitting hole 112 formed in the second plate 100B, but may be fitted into, for example, another fitting hole (not illustrated) separately formed in the hub 200 to rotate integrally with the hub 200 about the rotation axis O. Alternatively, the fitting portion 501 may be designed not to be fitted into either the second plate 100B or the hub 200.

As illustrated in FIG. 3A, the principal portion 502 includes a first surface 502x slidable with respect to the second plate 100B, and a second surface 502y slidable with respect to the hub 200. With this arrangement, the principal portion 502 can slide with respect to the second plate 100B and/or the hub 200, to generate a sliding torque (a third sliding torque) different from the first sliding torque and the second sliding torque described above.

As illustrated in FIG. 3B, a cutout portion 502z extending in a substantially annular shape can be formed in the second surface 502y of the principal portion 502. In a case where such a cutout portion 502z is provided, the size of the cutout portion 502z is adjusted so that the sliding area of the second surface 502y with respect to the hub 200 and the magnitude of the third sliding torque can be adjusted.

Note that, in the damper device 1 according to the embodiment illustrated in FIGS. 1 to 6, the second elastic member 604 of the first sliding portion 600 biases a plate portion 602 in the direction toward the control plate 300 (the leftward direction in the planes of FIGS. 3A and 3B), as described later. At this point of time, the reaction force relating to the biasing is transmitted from the second elastic member 604 to the first plate 100A, so that the first plate 100A is slightly biased in the direction away from the control plate 300 (the rightward direction in the planes of FIGS. 3A and 3B). In conjunction with this, the second plate 100B integrated with the first plate 100A via the rivets 120 is also slightly biased in the direction toward the control plate 300 (the rightward direction in the planes of FIGS. 3A and 3B). As a result, the second surface 502y of the thrust member 500 is pressed against the hub 200, and the above-mentioned third sliding torque is generated.

The third sliding torque is always generated when the disc plate 100 and the hub 200 rotate relative to each other, and can be used for forming a “low hysteresis torque” and for forming a “high hysteresis torque” in the damper device 1. Note that, in the damper device 1 according to the embodiment illustrated in FIGS. 1 to 6, a “low hysteresis torque” means a total torque of the second sliding torque and the third sliding torque described above, and a “high hysteresis torque” means a total torque of the first sliding torque and the third sliding torque described above.

### 1-6. First Sliding Portion 600

In the embodiment, the first sliding portion 600 is disposed between the disc plate 100 (first plate 100A) and the control plate 300, and slides with respect to the radially extending portions 302 (radially extending portions 302a to 302d) of the control plate 300, to generate the first sliding torque.

As illustrated in FIGS. 3A, 3B, and 4, the first sliding portion 600 according to the embodiment can include the substantially annular plate portion 602 including the first sliding surface 602a that slides with respect to the radially extending portions 302 (radially extending portions 302a to 302d) of the control plate 300, and the second elastic member 604 that biases the first sliding surface 602a of the plate portion 602 in the direction toward the radially extending portions 302 of the control plate 300 (the leftward direction in the planes of FIGS. 3A and 3B).

As illustrated in FIG. 4, the plate portion 602 may include an opening (first opening) 602A penetrating the cylindrical portion 202 of the hub 200. With this arrangement, the plate portion 602 is rotatably supported by the outer peripheral surface of the cylindrical portion 202 of the hub 200 on the inner peripheral surface surrounding the opening 602A. In the embodiment, the plate portion 602 may be formed as a bush. With this arrangement, the plate portion 602 is rotatably supported by the hub 200 in a simple and reliable manner, and thus, the assemblability of the plate portion 602 to the hub 200 can be enhanced. Further, the plate portion 602 formed as a bush can keep the hub 200 from being inclined with respect to the drive shaft Z.

As illustrated as an example in FIG. 3C, the plate portion 602 can include, on the first sliding surface 602a, a first vertex portion 602a₁ in contact with the radially extending portion 302 of the control plate 300, a first inclined surface 602a₂ connected to the first vertex portion 602a₁, and a second inclined surface 602a₃ connected to the first vertex portion 602a₁. The first inclined surface 602a₂ can extend in the direction away from the rotation axis (which is the rotation axis O) of the first sliding portion 600 (the upward direction in FIG. 3C) with respect to the first vertex portion 602a₁, and be inclined in the direction away from the control plate 300 (the rightward direction in FIG. 3C). The second inclined surface 602a₃ can extend in the direction toward the rotation axis (which is the rotation axis O) of the first sliding portion 600 (the downward direction in FIG. 3C) with respect to the first vertex portion 602a₁, and be inclined in the direction away from the control plate 300 (the rightward direction in FIG. 3C). As a result, the first sliding portion 600 can come into contact with and slide on the first vertex portion 602a₁ of the first sliding surface 602a with respect to the radially extending portion 302 of the control plate 300.

Further, as illustrated in FIG. 4, the plate portion 602 can include a first engaging portion 602B having a substantially annular shape, and a second engaging portion 602C disposed in the vicinity of the outer peripheral edge of the plate portion 602. The first engaging portion 602B can include a plurality of convex portions 602B1 protruding in the radial direction on the outer peripheral surface thereof. Such a first engaging portion 602B can be inserted into and engaged with a hole 108 formed in the first plate 100A. The second engaging portion 602C can include a plurality of convex portions 602C1 that are arranged at intervals in the circumferential direction and protrude in the axial direction. The plurality of convex portions 602C1 can be inserted into and engaged with a recess (not illustrated) formed in the first plate 100A. With this arrangement, the first sliding portion 600 is designed to be able to rotate integrally with the disc plate 100.

The first engaging portion 602B of the plate portion 602 is inserted into an opening 604a of the second elastic member 604, so that the second elastic member 604 is supported by the first engaging portion 602B. Such a second elastic member 604 is in contact with the first plate 100A on one surface, and is in contact with the plate portion 602 on the other surface. Thus, the second elastic member 604 can bias the plate portion 602 toward the control plate 300.

With such a configuration, when the control plate 300 rotates relative to the disc plate 100, the first vertex portion 602a₁ of the first sliding surface 602a is pressed against the radially extending portion 302, so that the first sliding portion 600 can generate the first sliding torque.

The plate portion 602 can be formed with a resin material, a metal material including a compound containing a 3d transition metal, or the like, for example. To increase (or decrease) the magnitude of the first sliding torque to be generated by sliding with the radially extending portion 302, it is preferable to separately apply a generally known friction material, or apply predetermined surface treatment to the first sliding surface 602a. As a result, the magnitude of the first sliding torque can be adjusted to a desired magnitude.

As the second elastic member 604, a generally known disc spring can be used, but the material for the second elastic member 604 is not limited to this. While being supported by the first plate 100A, the second elastic member 604 biases the first sliding surface 602a of the plate portion 602 in the direction toward the radially extending portion 302 of the control plate 300 (the leftward direction in the planes of FIGS. 3A and 3B), as described above. Meanwhile, the reaction force associated with the biasing is transmitted from the second elastic member 604 to the first plate 100A.

### 1-7. Second Sliding Portion 700

Referring to FIG. 3A, in the embodiment, the second sliding portion 700 is disposed between the control plate 300 and the hub 200, and slides at least with respect to the hub 200, to generate the second sliding torque.

In the embodiment, the second sliding portion 700 has a substantially annular shape as a whole, and includes a second sliding surface 702a slidable with respect to the hub 200. Therefore, in a case other than the “predetermined case” mentioned above, the second sliding portion 700 rotates relative to the hub 200, and the second sliding surface 702a slides with respect to the hub 200, to generate the second sliding torque.

Incidentally, the control plate 300 is biased in the direction toward the hub 200 in conjunction with the biasing of the plate portion 602 of the first sliding portion 600 in the direction toward the control plate 300 by the second elastic member 604 of the first sliding portion 600 described above. Further, the biased control plate 300 biases the second sliding portion 700 in the direction toward the hub 200. As a result, the second sliding surface 702a of the second sliding portion 700 is pressed against the hub 200, so that the second sliding torque is reliably generated. That is, the biasing force of the second elastic member 604 is sequentially transmitted to the plate portion 602, the control plate 300, and the second sliding portion 700.

Note that the second sliding portion 700 may include a second sliding surface 702b that can slide with respect to the control plate 300, to generate the second sliding torque. When the control plate 300 and the second sliding portion 700 are designed to be rotatable with respect to each other, the second sliding surface 702b and the radially extending portions 302 of the control plate 300 slide, to generate the second sliding torque.

In the embodiment, the second sliding portion 700 may be designed to be engaged with the control plate 300 and rotate integrally with the control plate 300, may be designed to be engaged with neither the control plate 300 nor the hub 200, or may be designed to be engaged with the first plate 100A, for example.

Like the other sliding surfaces, the second sliding surfaces 702a and 702b are preferably provided with a generally known friction material, or are preferably subjected to predetermined surface treatment.

### 1-8. Relationship Between the First Sliding Portion 600 and the Thrust Member 500

In a conventional damper device, in a case where no measures are taken, there normally is a possibility that a deviation occurs between the rotation center on the input side and the rotation center on the output side, or, in other words, there normally is a possibility that a deviation occurs between the rotation center of the drive shaft Z and the rotation center of the input shaft of the transmission. Such a deviation might occur, for example, firstly, in the phase in which the input shaft of the transmission is attached to the damper device 1, and secondly, in the phase in which the damper device 1 functions as a limiter in an actually used state.

In a case where such a deviation occurs, the rotation axis of the hub 200 through which the input shaft of the transmission is inserted is inclined with respect to the drive shaft Z (also, with respect to the disc plate 100 and the like connected to the drive shaft Z). Accordingly, the first sliding portion 600 (which is the first sliding surface 602a of the plate portion 602) supported by the hub 200 is inclined with respect to the drive shaft Z, and furthermore, with respect to the flywheel 2 and the disc plate 100 connected to the flywheel 2. In this case, there is a possibility that the first sliding surface 602a of the first sliding portion 600 does not slide on the control plate 300 as originally intended. As an example, there is a possibility that a place where the first sliding surface 602a of the first sliding portion 600 comes into contact with the control plate 300 and slides thereon deviates in the radial direction from the originally intended place (or the radius of action of the first sliding surface 602a on the control plate 300 changes compared with the originally intended radius of action). Further, in this case, there also is a possibility that the area of the portion that comes into contact with and slides between the first sliding surface 602a and the control plate 300 changes, and the magnitude of the first sliding torque changes.

To reduce such changes in sliding of the first sliding surface 602a with respect to the control plate 300, a configuration as described below can be adopted.

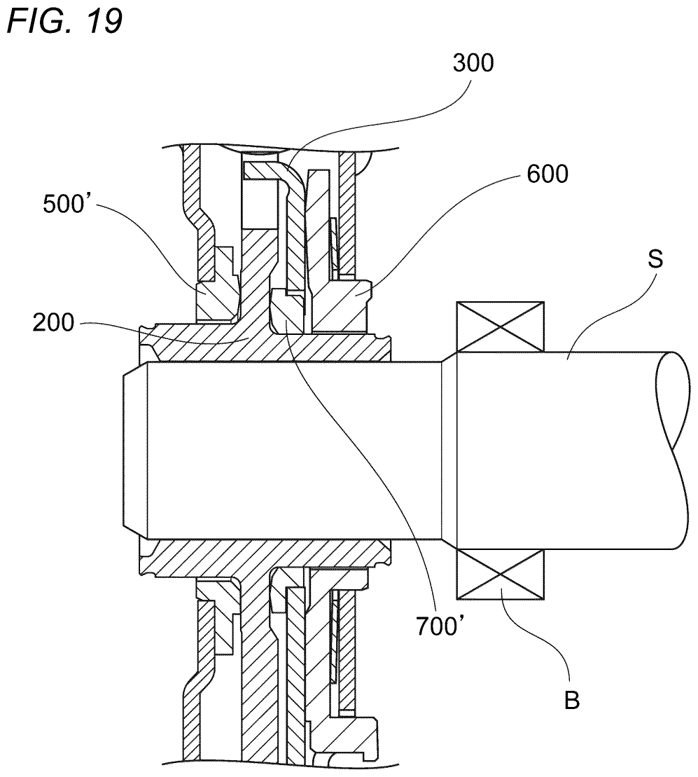

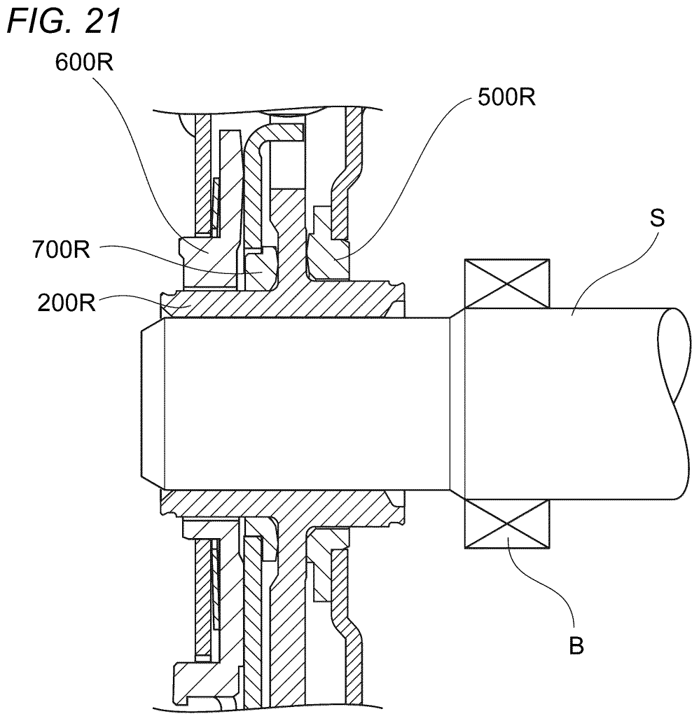

In the embodiment, a bearing (not illustrated) that rotatably supports the input shaft of the transmission may be disposed on the output side of the damper device 1, which is the right side of the damper device 1 in FIGS. 3A and 3B (regarding such a bearing, see the bearing B that rotatably supports the input shaft S of the transmission in FIGS. 19 and 21, which will be referred to later). In this case, between the first sliding portion 600 and the thrust member 500, the first sliding portion 600 is disposed closer to such a bearing (which is the transmission). That is, the distance between the bearing and the first sliding portion 600 is shorter than the distance between the bearing and the thrust member 500.

In the embodiment, the gap (a gap G₁ illustrated in FIG. 3B) provided between the inner peripheral surface surrounding the opening (first opening) 602A formed in the plate portion 602 of the first sliding portion 600 (disposed closer to the bearing) and the outer peripheral surface of the hub 200 can be formed to be narrower than the gap (a gap G₂ illustrated in FIG. 3B) provided between the inner peripheral surface surrounding the opening (second opening) 500a formed in the thrust member 500 (disposed farther from the bearing) and the outer peripheral surface of the hub 200. With this arrangement, the angle at which the hub 200 is inclined with respect to the drive shaft Z, and eventually, the angle at which the first sliding surface 600a of the first sliding portion 600 supported by the hub 200 is inclined with respect to the control plate 300 can be made smaller (compared with that in a case where G₁>G₂). As a result, the possibility that the radius of action on the control plate 300 by the first sliding surface 602a changes can be made lower, compared with the originally intended radius of action.

Further in the embodiment, the first sliding portion 600 can come into contact with and slide on the first vertex portion 602a₁ of the first sliding surface 602a with respect to the radially extending portions 302 of the control plate 300, as described above. With this arrangement, even in a case where the hub 200 is inclined with respect to the drive shaft Z, the first sliding surface 602a slides on the first vertex portion 602a₁ with respect to the control plate 300 while being in contact with the first vertex portion 602a₁, so that the area of the portion in contact between the first sliding surface 602a and the control plate 300 does not change significantly. As a result, the magnitude of the first sliding torque is prevented from changing.

Furthermore, in the embodiment, the plate portion 602 of the first sliding portion 600 may be formed as a bush, as described above. With this arrangement, the plate portion 602 can easily and effectively prevent a situation in which the hub 200 is inclined with respect to the drive shaft Z, which is a situation in which the radius of action on the control plate 300 by the first sliding surface 602a changes compared with the originally intended radius of action.

### 2. Operation of the Damper Device

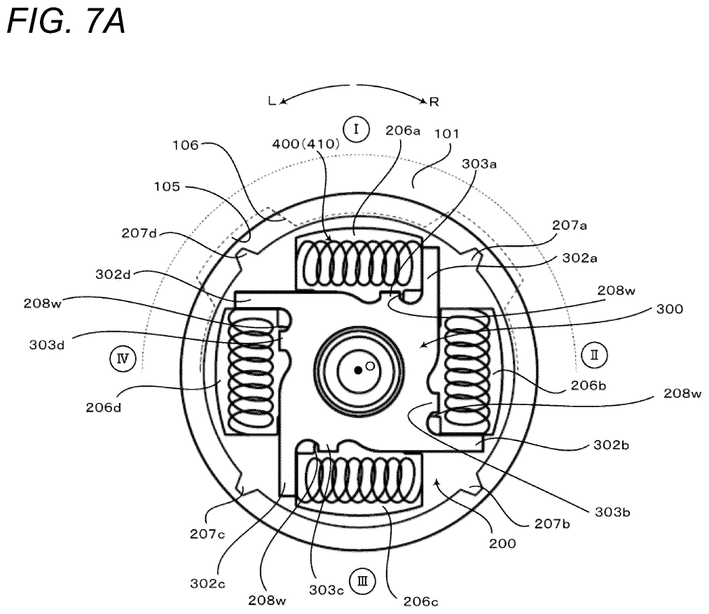

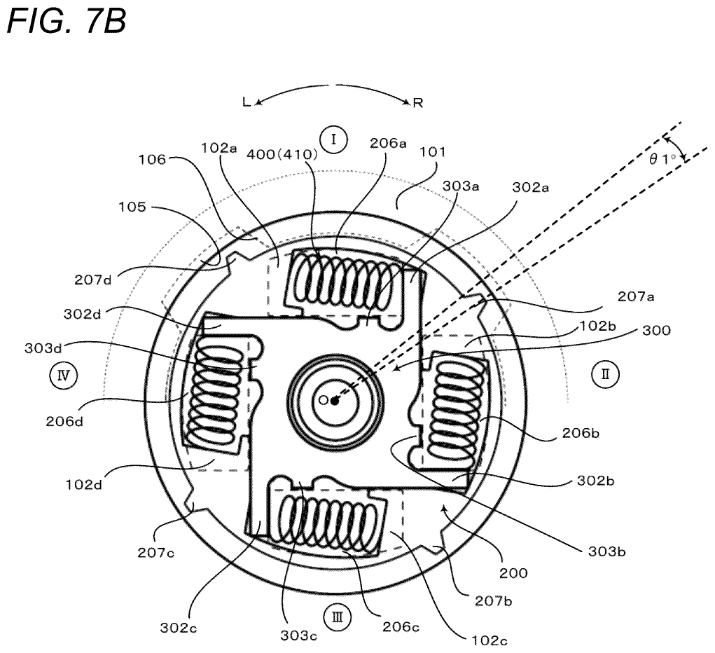

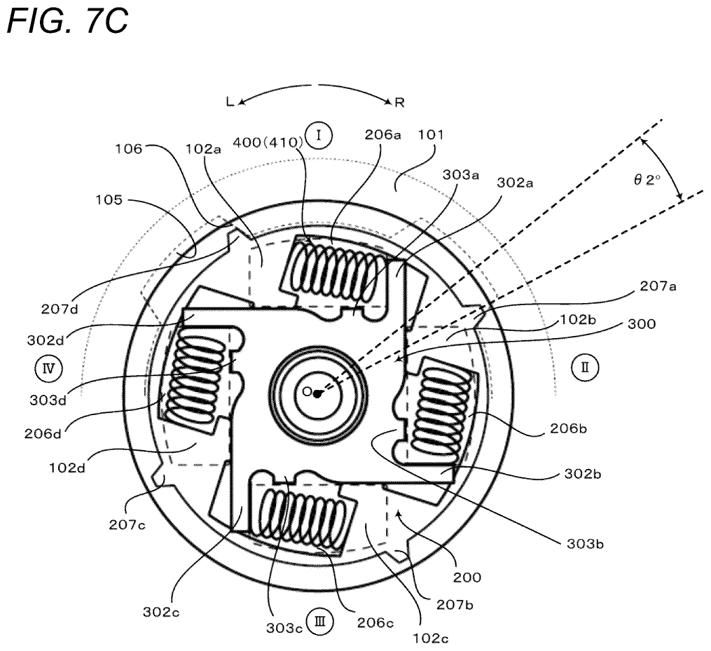

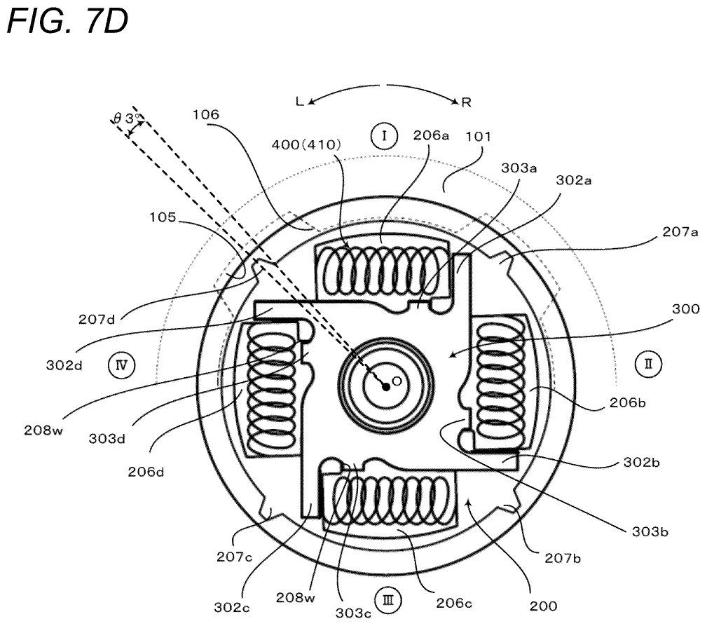

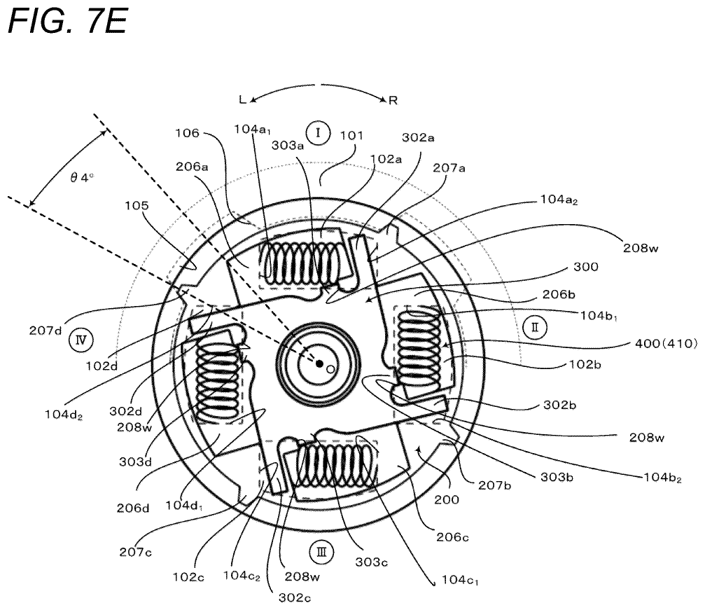

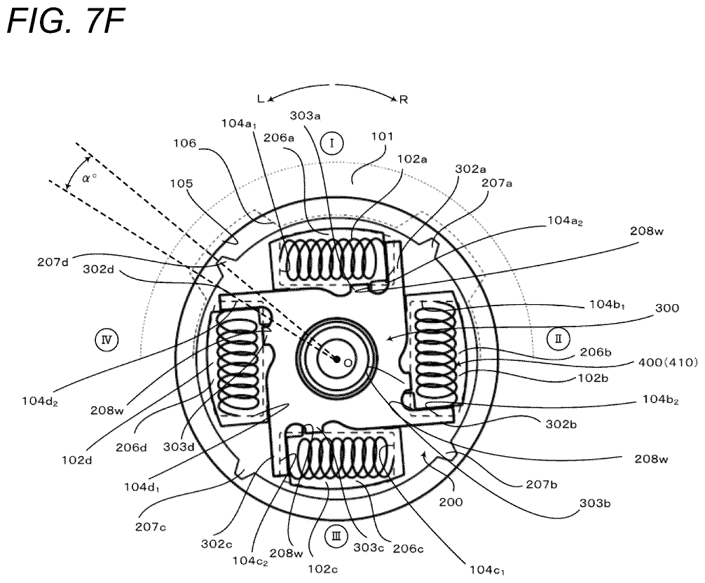

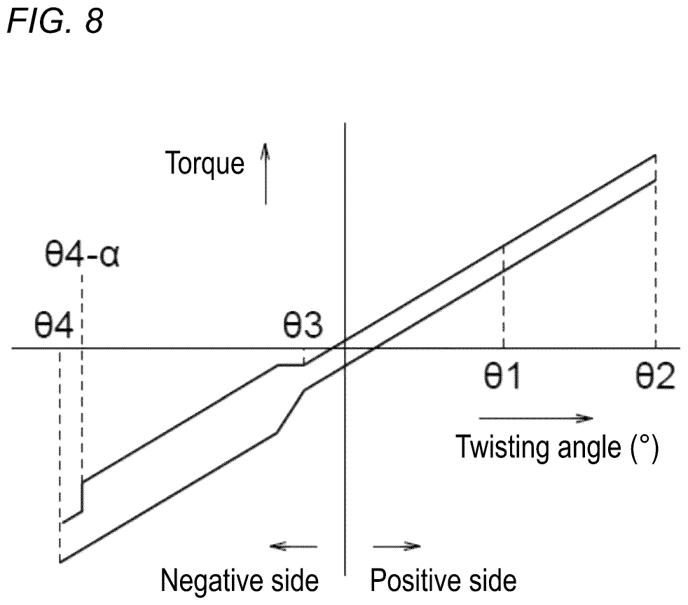

Next, the operation of the damper device 1 having the above configuration is described with reference to FIGS. 7A to 7F and FIG. 8. FIG. 7A is a schematic top view schematically illustrating a state in which the first rotating body (the disc plate 100) and the second rotating body (the hub 200) do not rotate relative to each other in the damper device 1 according to the embodiment. FIG. 7B is a schematic top view schematically illustrating a state in which the second rotating body (the hub 200) rotates relative to the first rotating body (the disc plate 100) at a twisting angle θ1° on the positive side in the damper device 1 according to the embodiment. FIG. 7C is a schematic top view schematically illustrating a state in which the second rotating body (the hub 200) rotates relative to the first rotating body (the disc plate 100) at a twisting angle θ2° on the positive side in the damper device 1 according to the embodiment. FIG. 7D is a schematic top view schematically illustrating a state in which the second rotating body (the hub 200) rotates relative to the first rotating body (the disc plate 100) at a twisting angle θ3° on the negative side in the damper device 1 according to the embodiment. FIG. 7E is a schematic top view schematically illustrating a state in which the second rotating body (the hub 200) rotates relative to the first rotating body (the disc plate 100) at a twisting angle θ4° on the negative side in the damper device 1 according to the embodiment. FIG. 7F is a schematic top view schematically illustrating a state in the middle of canceling of the relative rotation of the second rotating body (the hub 200) with respect to the first rotating body (the disc plate 100) from the state illustrated in FIG. 7E, in the damper device 1 according to the embodiment. FIG. 8 is a schematic characteristics diagram schematically illustrating the torsion characteristics in the damper device 1 according to the embodiment. Note that, in FIGS. 7A to 7F, the pair of sheet members 420 (the sheet member 420A and the sheet member 420B) in each elastic mechanical unit 400 are not shown, for convenience sake.

FIG. 7A illustrates a state in which power from the drive source such as an engine or a motor is transmitted to the damper device 1, but relative rotation does not occur between the disc plate 100 and the hub 200 (twisting angle: 0°). In this case, none of the first sliding torque, the second sliding torque, and the third sliding torque is generated.

Note that, in a state where no relative rotation occurs between the disc plate 100 and the hub 200 illustrated in FIG. 7A, the axially extending portions 303a to 303d of the control plate 300 are accommodated in the corresponding grooves 208a to 208d of the hub 200 at positions close to the wall portions 208w defining the grooves 208a to 208d. That is, gaps of the same distance are formed between the axially extending portion 303a and the wall portion 208w, between the axially extending portion 303b and the wall portion 208w, between the axially extending portion 303c and the wall portion 208w, and between the axially extending portion 303d and the wall portion 208w, and the axially extending portions 303a to 303d are not in contact with the respective wall portions 208w.

Next, FIG. 7B illustrates a case where, in the state illustrated in FIG. 7A, relative rotation occurs between the disc plate 100 and the hub 200, and a twist of θ1° occurs on the positive side. Here, the positive side means a case where the hub 200 relatively rotates (moves) in the R direction (the clockwise direction in FIG. 7B) with respect to the disc plate 100, for example. In this case, the hub 200 rotates relative to the disc plate 100 while bending the first elastic members 410. Also, at twisting angles of 0° to θ1°, the length of the gaps between the axially extending portions 303a to 303d and the respective corresponding wall portions 208w becomes gradually greater, and thus, the axially extending portions 303 and the wall portions 208w are not in contact with each other yet. Therefore, the control plate 300 is not affected by the relative rotation of the hub 200 with respect to the disc plate 100, and does not rotate relative to the disc plate 100. On the other hand, the control plate 300 rotates relative to the hub 200 (the hub 200 rotates relative to the control plate 300).

In this case (from the state illustrated in FIG. 7A to the state illustrated in FIG. 7B), as described above with reference to FIG. 3A, the sliding between the second surface 502y of the thrust member 500 that rotates integrally with the disc plate 100 and the hub 200 (the disc portion 205) generates the third sliding torque mentioned above. Also, the second sliding surface 702a of the second sliding portion 700 slides with respect to the hub 200 (the disc portion 205) on the basis of the relative rotation between the hub 200 and the control plate 300, to generate the second sliding torque. Note that, as described above, in a case where the second sliding portion 700 is rotatable with respect to the control plate 300, the second sliding torque may be generated by sliding between the sliding surface 702b of the second sliding portion 700 and the radially extending portions 302 (the radially extending portions 302a to 302d) of the control plate 300.

As described above, from the state illustrated in FIG. 7A to the state illustrated in FIG. 7B, the total torque of the third sliding torque and the second sliding torque is generated as a hysteresis torque, and the hysteresis torque in this case corresponds to a “low hysteresis torque”.

Next, FIG. 7C illustrates a case where the relative rotation of the hub 200 with respect to the disc plate 100 further progresses from the state illustrated in FIG. 7B, and a twist of θ2° occurs on the positive side. In this case, the hub 200 rotates relative to the disc plate 100 while further bending the first elastic members 410. Also, at a twisting angle of θ2°, the protrusions 207a to 207d of the hub 200 come into contact with the restricting portions 106 provided on the lining plate 101. With this arrangement, the hub 200 is restricted from rotating relatively on the positive side by θ2° or more, and thus, the twisting angle of θ2° can be regarded as the maximum twisting angle on the positive side.

Note that, at twisting angles of θ1° to θ2°, the length of the gaps between the axially extending portions 303a to 303d and the respective corresponding wall portions 208w becomes gradually greater, and thus, the axially extending portions 303a to 303d and the wall portions 208w are not in contact with each other. Therefore, the control plate 300 is not affected by the relative rotation of the hub 200 with respect to the disc plate 100, and does not rotate relative to the disc plate 100. On the other hand, the control plate 300 rotates relative to the hub 200 (the hub 200 rotates relative to the control plate 300).

In this case (from the state illustrated in FIG. 7B to the state illustrated in FIG. 7C), the third sliding torque and the second sliding torque are generated as in the case of the transition from the state in FIG. 7A to the state in FIG. 7B. Therefore, a “low hysteresis torque” is also generated in the transition from the state in FIG. 7B to the state in FIG. 7C.

Next, FIG. 7D illustrates a case where, in the state illustrated in FIG. 7A, relative rotation occurs between the disc plate 100 and the hub 200, and a twist of θ3° occurs on the negative side. Here, the negative side means a case where the hub 200 relatively rotates (moves) in the L direction (the counterclockwise direction in FIG. 7D) with respect to the disc plate 100, for example. In this case, the hub 200 rotates relative to the disc plate 100 while bending the first elastic members 410. Further, at twisting angles of 0° to θ3°, the length of the gaps between the axially extending portions 303a to 303d and the respective corresponding wall portions 208w becomes gradually smaller, and thus, the axially extending portions 303a to 303d and the wall portions 208w come into contact with each other (the gaps become nonexistent) at the twisting angle θ3°. Therefore, at twisting angles of 0° to θ3°, the control plate 300 is not affected by the relative rotation of the hub 200 with respect to the disc plate 100, and does not rotate relative to the disc plate 100 yet. On the other hand, the control plate 300 rotates relative to the hub 200 (the hub 200 rotates relative to the control plate 300).

Meanwhile, the radially extending portions 302a to 302d of the control plate 300 are basically in contact with the elastic mechanical units 400 in the respective regions I to IV. For example, in a case where the hub 200 does not rotate relative to the disc plate 100 (the state in FIG. 7A) and in a case where the hub 200 rotates relative to the disc plate 100 on the positive side (the states in FIGS. 7B and 7C), the radially extending portions 302a to 302d are always in contact with the elastic mechanical units 400. However, as the twisting angle changes from 0° to θ3°, this contact relationship is gradually dissolved. That is, at twisting angles of 0° to θ3°, gaps are formed between the radially extending portions 302a to 302d of the control plate 300 and the first elastic members 410 (the elastic mechanical units 400), and the length (size) of the gaps becomes gradually greater. This is in conjunction with the elimination of the gaps between the axially extending portions 303a to 303d and the wall portions 208w as described above.

In this case (from the state illustrated in FIG. 7A to the state illustrated in FIG. 7D), the third sliding torque and the second sliding torque mentioned above are generated as in the case of the transition from the state in FIG. 7A to the state in FIG. 7B. Therefore, a “low hysteresis torque” is also generated in the transition from the state in FIG. 7A to the state in FIG. 7D.

Next, FIG. 7E illustrates a case where the relative rotation of the hub 200 with respect to the disc plate 100 further progresses from the state illustrated in FIG. 7D, and a twist of θ4° occurs on the negative side. In this case, the hub 200 rotates relative to the disc plate 100 while further bending the first elastic members 410. Also, at a twisting angle of θ4°, the protrusions 207a to 207d of the hub 200 come into contact with the restricting portions 106 provided on the lining plate 101. With this arrangement, the hub 200 is restricted from rotating relatively on the negative side by θ4° or more, and thus, the twisting angle of θ4° can be regarded as the maximum twisting angle on the negative side. In this case, the gaps formed in the state in FIG. 7D still continue to be formed between the radially extending portions 302a to 302d of the control plate 300 and the elastic mechanical units 400 (the first elastic members 410).

Note that, at twisting angles θ3° to θ4°, the axially extending portions 303a to 303d are in contact with the corresponding wall portions 208w. Accordingly, the control plate 300 (the axially extending portions 303a to 303d) is guided by the hub 200 (the wall portions 208w), to relatively rotate integrally with the hub 200 (integrally with the hub 200) in the L direction with respect to the disc plate 100.

In this case (from the state in FIG. 7D to the state in FIG. 7E), the disc plate 100 and the hub 200 also rotate relative to each other, and therefore, the third sliding torque is generated as in the case of the transition from the state in FIG. 7A to the state in FIG. 7B. In this case, the control plate 300 also rotates relative to the disc plate 100, and therefore, the first sliding torque is generated between the first sliding surface 602a of the first sliding portion 600 and the radially extending portions 302 (the radially extending portions 302a to 302d) of the control plate 300, as described above. Note that, in this case, the hub 200 and the control plate 300 rotate integrally, and therefore, the second sliding torque is not generated. Further, it is assumed that the first sliding torque to be generated in this case is set to a higher torque than the second sliding torque in advance. Regarding such setting, the friction coefficients of the first sliding surface 602a that generates the first sliding torque and the radially extending portions 302a to 302d are adjusted as appropriate by any of the methods described above.

As described above, from the state illustrated in FIG. 7D to the state illustrated in FIG. 7E, the total torque of the third sliding torque and the first sliding torque is generated as a hysteresis torque, and the hysteresis torque in this case corresponds to a “high hysteresis torque”.

Next, FIG. 7F illustrates a state in the process of transition from the maximum twisting angle θ4° toward the twisting angle 0° on the negative side while the relative rotation of the hub 200 with respect to the disc plate 100 is being canceled, in the state illustrated in FIG. 7E. In this case, the hub 200 relatively moves in the R direction toward the twisting angle of 0° while gradually eliminating the deflection of the first elastic members 410. That is, the twisting angle in the state in FIG. 7F can be a twisting angle between θ3° and θ4°, for example.

In this case, first, when the hub 200 relatively moves in the R direction (moves so as to eliminate the relative rotation in the L direction) from the twisting angle θ4°, the contact relationship between the axially extending portions 303a to 303d and the corresponding wall portions 208w is dissolved, and gaps are sequentially formed again therebetween. That is, the rotation of the control plate 300 in the R direction (the relative rotation with respect to the disc plate 100) is not to be guided by the hub 200. Therefore, there appears a slight time difference between the timing of cancellation of the relative rotation of the hub 200 on the negative side with respect to the disc plate 100 and the timing of cancellation of the relative rotation of the control plate 300 on the negative side with respect to the disc plate 100.

When the hub 200 relatively moves in the R direction by a predetermined angle (the predetermined angle is set to α°, for example) to eliminate the relative rotation on the negative side from the twisting angle θ4° before the control plate 300 (without guiding the control plate 300), the gaps between the radially extending portions 302a to 302d of the control plate 300 and the respective elastic mechanical units 400 formed in the state illustrated in FIG. 7D (and FIG. 7E) become gradually narrower, and finally disappear. As a result, the radially extending portions 302a to 302d of the control plate 300 again come into contact with the elastic mechanical units 400. In this state, the elastic mechanical units 400 are still in a deflected state, and accordingly, the elastic mechanical units 400 push (bias) the control plate 300 in the R direction. Thus, the control plate 300 relatively rotates in the R direction with respect to the disc plate 100, on the basis of the biasing force generated by the deflection of the elastic mechanical units 400.

As for a further explanation of the above flow, only the hub 200 rotates relative to the disc plate 100 in the R direction at twisting angles θ4° to θ4-α°, and thus, the third sliding torque and the second sliding torque are generated as in the case of the transition from the state in FIG. 7A to the state in FIG. 7B. That is, a “low hysteresis torque” is generated. On the other hand, from θ4-α° to 0°, not only the hub 200 but also the control plate 300 rotates relative to the disc plate 100 in the R direction, and thus, the third sliding torque and the first sliding torque are generated as in the case of the transition from the state in FIG. 7D to the state in FIG. 7E. That is, a “high hysteresis torque” is generated.

On the basis of the flow in the operation of the damper device 1 described above with reference to FIGS. 7A to 7F, the torsion characteristics of the damper device 1 are as illustrated in FIG. 8.

Meanwhile, the “high hysteresis torque” to be generated only on the negative side as described above, which is the hysteresis torque obtained by adding the first sliding torque and the third sliding torque, is suitably used when a hybrid vehicle absorbs torque fluctuations that occur when the engine is started under some conditions in a state where the engine has been stopped and the vehicle is being driven only by the motor, for example. Also, as described above, on the positive side, the “low hysteresis torque”, which is the hysteresis torque obtained by adding the second sliding torque and the third sliding torque, can be generated. As described above, in the damper device 1 according to the embodiment, only one control plate 300 is used, so that a relatively low hysteresis torque can be generated on the positive side and a relatively high hysteresis torque can be generated on the negative side, while the axial length of the damper device 1 is made shorter. Thus, various variations of hysteresis torque can be stably generated. Also, in the damper device 1 according to the embodiment, the first sliding torque is generated mainly at the radially extending portions 302 of the control plate 300 via the first sliding portion 600. Thus, the damper device 1 can be relatively easily designed from the viewpoint of the shape, structure, strength, and the like of the control plate 300.

### 3. Modifications

### 3-1. Second Embodiment

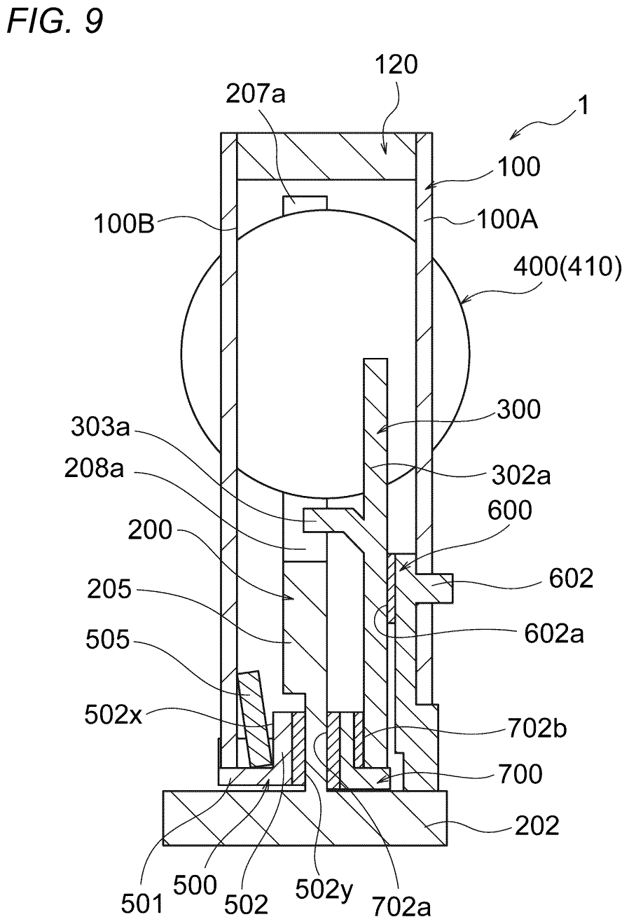

Next, the configuration of a damper device 1 according to a second embodiment is described with reference to FIG. 9. FIG. 9 is a schematic cross-sectional view schematically illustrating the configuration of the damper device 1 according to the second embodiment. Note that FIG. 9 is a diagram for briefly explaining that the damper device 1 according to the second embodiment includes components described below that are different from those of the damper device 1 according to the embodiment, and is a diagram focusing on the portion related to the region I. Therefore, the components common between the damper device 1 according to the embodiment illustrated in FIG. 3A and others, and the damper device 1 according to the second embodiment illustrated in FIG. 9 are illustrated as slightly different from each other in FIG. 9 for convenience sake. However, it should be understood that the shapes and the like of the components according to both embodiments are the same, except for the different components described below, unless otherwise specified.

The damper device 1 according to the second embodiment has substantially the same configuration as the damper device 1 according to the embodiment described above, but the configurations of the thrust member 500 and the first sliding portion 600 are different from those of the embodiment described above. Note that, as for the damper device 1 according to the second embodiment, the same components as those of the damper device 1 according to the above embodiment are not described in detail herein.

The thrust member 500 in the damper device 1 according to the second embodiment includes not only the combined component formed with the substantially cylindrical fitting portion 501 and the substantially annular principal portion 502 described above, but also a fourth elastic member 505 that biases the combined component in the direction toward the hub 200 (the rightward direction in the plane of FIG. 9). As the fourth elastic member 505, a generally known disc spring can be used, but the material for the fourth elastic member 505 is not limited to this.

On the other hand, the first sliding portion 600 in the damper device 1 according to the second embodiment does not include the second elastic member 604, which is a component in the embodiment, but is formed only with the plate portion 602.

With the damper device 1 according to the second embodiment having the above configuration, the second surface 502y of the thrust member 500 is pressed against the hub 200 (the disc portion 205) by the biasing force of the fourth elastic member 505. As a result, the third sliding torque can be reliably and efficiently generated when the disc plate 100 and the hub 200 rotate relative to each other.

Meanwhile, in conjunction with the fourth elastic member 505 biasing the second surface 502y in the direction toward the hub 200, the reaction force related to the biasing is transmitted from the fourth elastic member 505 to the second plate 100B. As a result, the second plate 100B is slightly biased in the direction away from the hub 200 (the leftward direction in the plane of FIG. 9). In conjunction with this, the first plate 100A integrated with the second plate 100B via the rivets 120 is also slightly biased in the direction toward the control plate 300 (the leftward direction in the plane of FIG. 9). The biasing force transmitted to the first plate 100A can be replaced with the biasing force generated by the second elastic member 604 according to the embodiment. Therefore, the first sliding portion 600 in the damper device 1 according to the second embodiment can generate the first sliding torque between the first sliding surface 602a of the first sliding portion 600 and the radially extending portion 302 of the control plate 300, even if the second elastic member 604, which is a component in the embodiment, is excluded.

Although not illustrated in FIG. 9, the plate portion 602 can include, on the first sliding surface 602a, a first vertex portion 602a₁ in contact with the radially extending portion 302 of the control plate 300, a first inclined surface 602a₂ connected to the first vertex portion 602a₁, and a second inclined surface 602a₃ connected to the first vertex portion 602a₁, as described above with reference to FIG. 3C.

Further, as described above with reference to FIG. 3B, the gap G₁ formed between the inner peripheral surface surrounding the opening (first opening) 602A formed in the plate portion 602 and the outer peripheral surface of the hub 200 can be smaller than the gap G₂ formed between the inner peripheral surface surrounding the opening (second opening) 500a formed in the thrust member 500 and the outer peripheral surface of the hub 200.

### 3-2. Third Embodiment

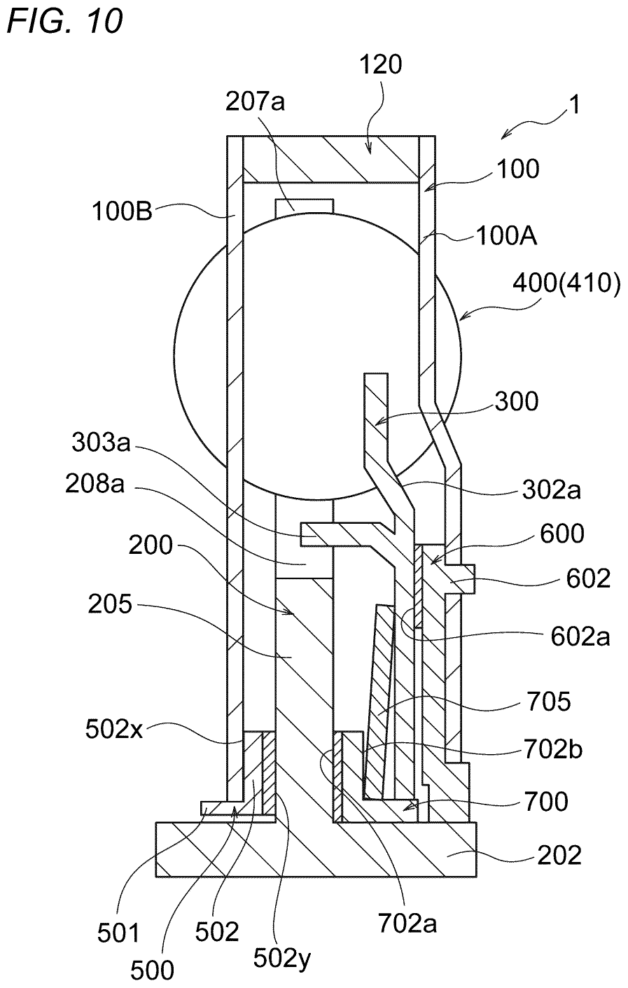

Next, the configuration of a damper device 1 according to a third embodiment is described with reference to FIG. 10. FIG. 10 is a schematic cross-sectional view schematically illustrating the configuration of the damper device 1 according to the third embodiment. Note that FIG. 10 is a diagram for briefly explaining that the damper device 1 according to the third embodiment includes components described below that are different from those of the damper device 1 according to the embodiment, and is a diagram focusing on the portion related to the region I. Therefore, the components common between the damper device 1 according to the embodiment illustrated in FIG. 3A and others, and the damper device 1 according to the third embodiment illustrated in FIG. 10 are illustrated as slightly different from each other in FIG. 10 for convenience sake. However, it should be understood that the shapes and the like of the components according to both embodiments are the same, except for the different components described below, unless otherwise specified.

The damper device 1 according to the third embodiment has substantially the same configuration as the damper device 1 according to the embodiment described above, but the configurations of the first sliding portion 600 and the second sliding portion 700 are different from those of the embodiment described above. Note that, as for the damper device 1 according to the third embodiment, the same components as those of the damper device 1 according to the above embodiment are not described in detail herein.

The second sliding portion 700 in the damper device 1 according to the third embodiment includes not only the combined component including the second sliding surface 702a (and 702b) having a substantially annular shape, but also a third elastic member 705 that biases the combined component in the direction toward the hub 200 (the leftward direction in the plane of FIG. 10). As the third elastic member 705, a generally known disc spring can be used, but the material for the third elastic member 705 is not limited to this.

On the other hand, the first sliding portion 600 in the damper device 1 according to the third embodiment does not include the second elastic member 604, which is a component in the embodiment, but is formed only with the plate portion 602.

With the damper device 1 according to the third embodiment having the above configuration, the second sliding surface 702a of the second sliding portion 700 is pressed against the hub 200 (the disc portion 205) by the biasing force of the third elastic member 705. As a result, when the disc plate 100 and the hub 200 rotate relative to each other, and the hub 200 rotates relative to the control plate 300 (the control plate 300 rotates relative to the hub 200), the second sliding torque can be reliably and efficiently generated.

On the other hand, in conjunction with the biasing of the third elastic member 705 in the direction in which the second sliding surface 702a is pressed against the hub 200, a reaction force related to the biasing is transmitted from the third elastic member 705 to the control plate 300. As a result, the control plate 300 is slightly biased in the direction toward the first plate 100A (the rightward direction in the plane of FIG. 10). Because of this, in the damper device 1 according to the third embodiment, the radially extending portion 302 of the control plate 300 is pressed against the first sliding surface 602a of the first sliding portion 600, and thus, the first sliding torque can be reliably and efficiently generated. In this configuration, the control plate 300 is biased in the direction toward the first plate 100A, and thus, the first sliding torque can be generated between the first sliding surface 602a of the first sliding portion 600 and the radially extending portion 302 of the control plate 300, even if the second elastic member 604, which is a component in the embodiment, is excluded.

Although not illustrated in FIG. 10, the plate portion 602 can include, on the first sliding surface 602a, a first vertex portion 602a₁ in contact with the radially extending portion 302 of the control plate 300, a first inclined surface 602a₂ connected to the first vertex portion 602a₁, and a second inclined surface 602a₃ connected to the first vertex portion 602a₁, as described above with reference to FIG. 3C.

Further, as described above with reference to FIG. 3B, the gap G₁ formed between the inner peripheral surface surrounding the opening (first opening) 602A formed in the plate portion 602 and the outer peripheral surface of the hub 200 can be smaller than the gap G₂ formed between the inner peripheral surface surrounding the opening (second opening) 500a formed in the thrust member 500 and the outer peripheral surface of the hub 200.

### 3-3. Fourth Embodiment

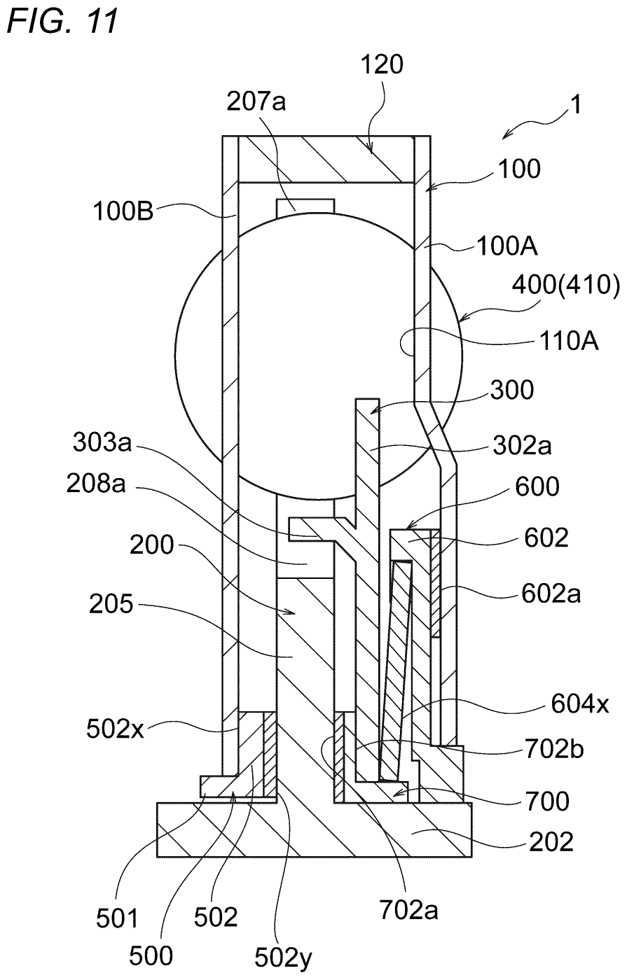

Next, the configuration of a damper device 1 according to a fourth embodiment is described with reference to FIG. 11. FIG. 11 is a schematic cross-sectional view schematically illustrating the configuration of the damper device 1 according to the fourth embodiment. Note that FIG. 11 is a diagram for briefly explaining that the damper device 1 according to the fourth embodiment includes components described below that are different from those of the damper device 1 according to the embodiment, and is a diagram focusing on the portion related to the region I. Therefore, the components common between the damper device 1 according to the embodiment illustrated in FIG. 3A and others, and the damper device 1 according to the fourth embodiment illustrated in FIG. 11 are illustrated as slightly different from each other in FIG. 11 for convenience sake. However, it should be understood that the shapes and the like of the components according to both embodiments are basically the same, except for the different components described below.

The damper device 1 according to the fourth embodiment has substantially the same configuration as the damper device 1 according to the embodiment described above, but the configuration of the first sliding portion 600 is different from that of the embodiment described above. Note that, as for the damper device 1 according to the fourth embodiment, the same components as those of the damper device 1 according to the above embodiment are not described in detail herein.

The first sliding portion 600 in the damper device 1 according to the fourth embodiment is the same as that of the embodiment in that the first sliding portion 600 includes the plate portion 602 and a second elastic member 604x (the second elastic member 604 in the embodiment). However, the second elastic member 604x biases the plate portion 602 not in the direction toward the control plate 300 (the leftward direction in the plane of FIG. 11) but in the direction toward the first plate 100A (the rightward direction in the plane of FIG. 11). Also, the first sliding portion 600 of the damper device 1 according to the fourth embodiment is designed to be engaged with the control plate 300 (for example, the plate portion 602 is engaged with the radially extending portion 302 of the control plate 300), unlike the first sliding portion 600 of the embodiment. Accordingly, the first sliding portion 600 can rotate integrally with the control plate 300. Note that the second elastic member 604x may be the same as the second elastic member 604 according to the embodiment.

With the above configuration, the damper device 1 according to the fourth embodiment can reliably and efficiently generate the first sliding torque between the first sliding surface 602a and the inner surface 110A of the first plate 100A by pressing the first sliding surface 602a of the first sliding portion 600 against the inner surface 110A of the first plate 100A when the control plate 300 and the disc plate 100 rotate relative to each other (this case is the “predetermined case” described above). Note that, in the embodiment, the surface of the plate portion 602 facing the control plate 300 is referred to as the first sliding surface 602a, as illustrated in FIG. 3A. In the fourth embodiment, on the other hand, the surface of the plate portion 602 facing the first plate 100A is referred to as the first sliding surface 602a, as illustrated in FIG. 11. Therefore, it should be understood that the first sliding surface 602a is the surface that generates the first sliding torque in the first sliding portion 600.

Meanwhile, in conjunction with biasing of the first sliding surface 602a in the direction toward the first plate 100A by the second elastic member 604x, the reaction force related to the biasing is transmitted from the second elastic member 604x to the control plate 300. As a result, the control plate 300 is slightly biased in the direction toward the hub 200 (the leftward direction in the plane of FIG. 11). Accordingly, in the damper device 1 according to the fourth embodiment, the second sliding surface 702a of the second sliding portion 700 is pressed against the hub 200 (the disc portion 205) by the reaction force interlocking with the biasing force of the second elastic member 604x. Thus, when the hub 200 and the control plate 300 rotate relative to each other, the second sliding torque can be reliably and efficiently generated.

Although not illustrated in FIG. 11, the plate portion 602 can include, on the first sliding surface 602a, a first vertex portion 602a₁ in contact with the first plate 100A, a first inclined surface 602a₂ that is connected to the first vertex portion 602a₁, extends in the direction away from the rotation axis O, and is inclined in the direction away from the first plate 100A, and a second inclined surface 602a₃ that is connected to the first vertex portion 602a₁, extends in the direction toward the rotation axis O, and is inclined in the direction away from the first plate 100A, as described above with reference to FIG. 3C.

Further, as described above with reference to FIG. 3B, the gap G₁ formed between the inner peripheral surface surrounding the opening (first opening) 602A formed in the plate portion 602 and the outer peripheral surface of the hub 200 can be smaller than the gap G₂ formed between the inner peripheral surface surrounding the opening (second opening) 500a formed in the thrust member 500 and the outer peripheral surface of the hub 200.

### 3-4. Fifth Embodiment

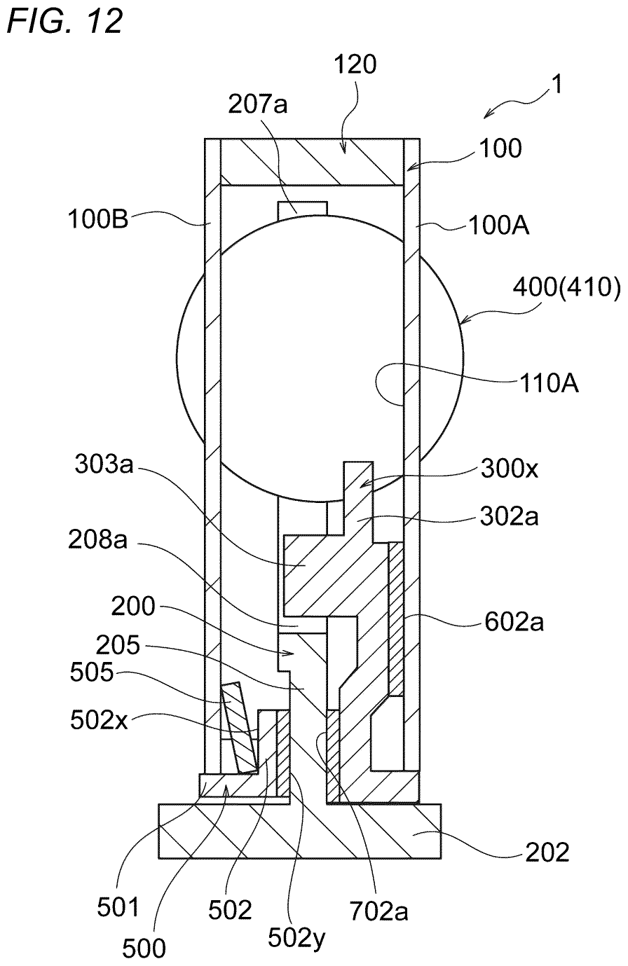

Next, the configuration of a damper device 1 according to a fifth embodiment is described with reference to FIG. 12. FIG. 12 is a schematic cross-sectional view schematically illustrating the configuration of the damper device 1 according to the fifth embodiment. Note that FIG. 12 is a diagram for briefly explaining that the damper device 1 according to the fifth embodiment includes components described below that are different from those of the damper device 1 according to the embodiment, and is a diagram focusing on the portion related to the region I. Therefore, the components common between the damper device 1 according to the embodiment illustrated in FIG. 3A and others, and the damper device 1 according to the fifth embodiment illustrated in FIG. 12 are illustrated as slightly different from each other in FIG. 12 for convenience sake. However, it should be understood that the shapes and the like of the components according to both embodiments are basically the same, except for the different components described below.

The damper device 1 according to the fifth embodiment has substantially the same configuration as the damper device 1 according to the embodiment described above, but the configurations of the thrust member 500, the first sliding portion 600, and the second sliding portion 700 are different from those of the embodiment described above. Note that, as for the damper device 1 according to the fifth embodiment, the same components as those of the damper device 1 according to the above embodiment are not described in detail herein.

The thrust member 500 in the damper device 1 according to the fifth embodiment includes not only the combined component formed with the substantially cylindrical fitting portion 501 and the substantially annular principal portion 502 described above, but also a fourth elastic member 505 that biases the combined component in the direction toward the hub 200 (the rightward direction in the plane of FIG. 12), as in the second embodiment. As the fourth elastic member 505, a generally known disc spring can be used, but the material for the fourth elastic member 505 is not limited to this.

Further, in the damper device 1 according to the fifth embodiment, the first sliding portion 600 and the second sliding portion 700 are formed integrally with the control plate 300. That is, the control plate 300, the first sliding portion 600, and the second sliding portion 700 are formed as one combined component. The combined component formed in this manner can be regarded as a control plate 300x (for convenience sake, the control plate in the fifth embodiment is referred to as the “control plate 300x”) that has both the functions of the first sliding portion 600 and the functions of the second sliding portion 700.

Accordingly, the control plate 300x according to the fifth embodiment can include, on the radially extending portion 302, the first sliding surface 602a that slides directly on the inner surface 110A of the first plate 100A to generate the first sliding torque, and the second sliding surface 702a that slides directly on the hub 200 (the disc portion 205) to generate the second sliding torque.

With the damper device 1 according to the fifth embodiment having the above configuration, the second surface 502y of the thrust member 500 is pressed against the hub 200 (the disc portion 205) by the biasing force of the fourth elastic member 505. As a result, the third sliding torque can be reliably and efficiently generated when the disc plate 100 and the hub 200 rotate relative to each other.

Meanwhile, in conjunction with the fourth elastic member 505 biasing the second surface 502y in the direction toward the hub 200, the reaction force related to the biasing is transmitted from the fourth elastic member 505 to the second plate 100B. As a result, the second plate 100B is slightly biased in the direction away from the hub 200 (the leftward direction in the plane of FIG. 12). In conjunction with this, the first plate 100A integrated with the first plate 100B via the rivets 120 is also slightly biased in the direction toward the control plate 300 (the leftward direction in the plane of FIG. 12). As a result, the inner surface 110A of the first plate 100A is pressed against the first sliding surface 602a of the control plate 300x. Thus, when the disc plate 100 and the control plate 300x rotate relative to each other, the first sliding torque can be reliably and efficiently generated between the first sliding surface 602a of the control plate 300x and the inner surface 110A of the first plate 100A.

Also, in conjunction with the pressing of the inner surface 110A of the first plate 100A against the first sliding surface 602a of the control plate 300x, the second sliding surface 702a of the control plate 300x is pressed against the hub 200 (the disc portion 205). As a result, when the control plate 300x and the hub 200 rotate relative to each other, the second sliding torque can be reliably and efficiently generated between the second sliding surface 702a of the control plate 300x and the hub 200.

Although not illustrated in FIG. 12, the control plate 300x can include, on the first sliding surface 602a, a first vertex portion 602a₁ in contact with the first plate 100A, a first inclined surface 602a₂ that is connected to the first vertex portion 602a₁, extends in the direction away from the rotation axis O, and is inclined in the direction away from the first plate 100A, and a second inclined surface 602a₃ that is connected to the first vertex portion 602a₁, extends in the direction toward the rotation axis O, and is inclined in the direction away from the first plate 100A, as described above with reference to FIG. 3C.

Further, as described above with reference to FIG. 3B, the gap G₁ formed between the inner peripheral surface surrounding the opening (first opening) 602A formed in the control plate 300x and the outer peripheral surface of the hub 200 can be smaller than the gap G₂ formed between the inner peripheral surface surrounding the opening (second opening) 500a formed in the thrust member 500 and the outer peripheral surface of the hub 200.

### 3-5. Sixth Embodiment

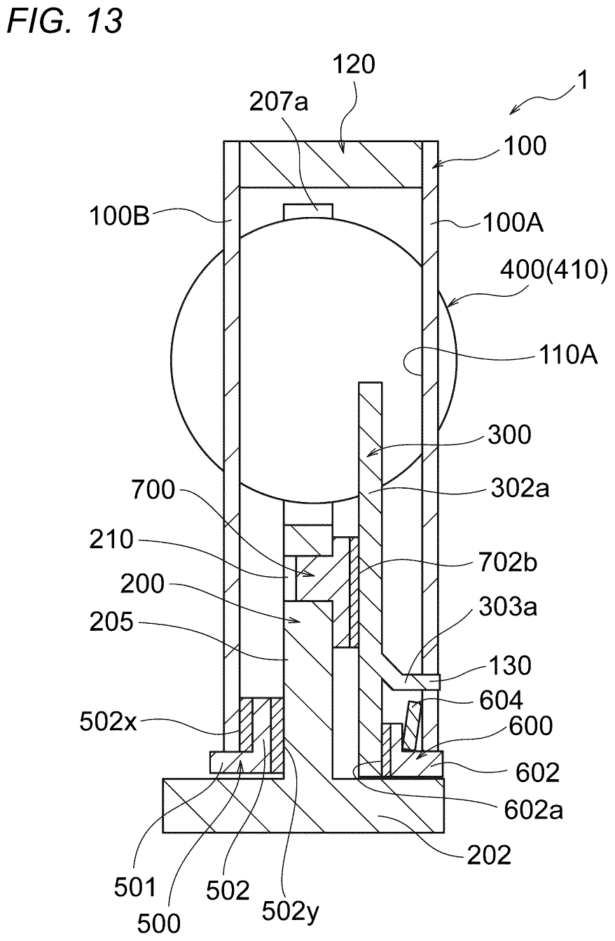

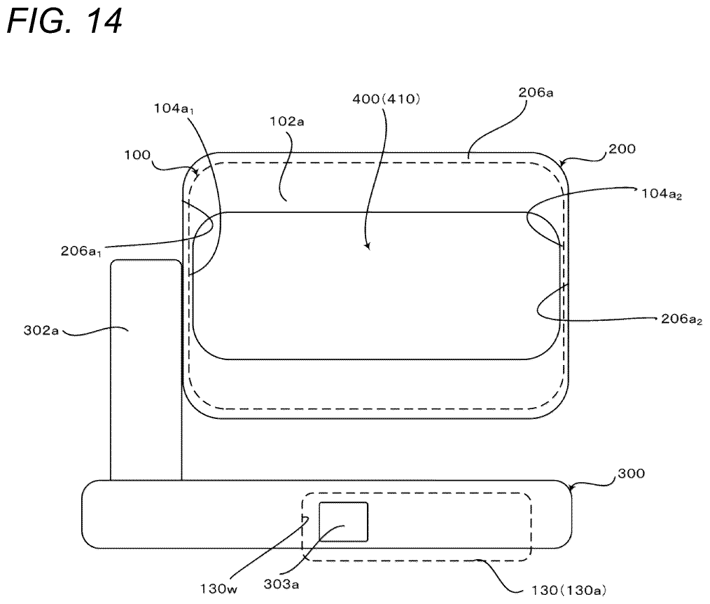

Next, the configuration of a damper device 1 according to a sixth embodiment is described with reference to FIGS. 13 and 14. FIG. 13 is a schematic cross-sectional view schematically illustrating the configuration of the damper device 1 according to the sixth embodiment. FIG. 14 is a schematic enlarged view schematically illustrating the relationship between the disc plate 100 and the control plate 300 in the damper device 1 according to the sixth embodiment. Note that FIG. 13 is a diagram for briefly explaining that the damper device 1 according to the sixth embodiment includes components described below that are different from those of the damper device 1 according to the embodiment, and is a diagram focusing on the portion related to the region I. Therefore, the components common between the damper device 1 according to the embodiment illustrated in FIG. 3A and others, and the damper device 1 according to the sixth embodiment illustrated in FIG. 13 are illustrated as slightly different from each other in FIG. 13 for convenience sake. However, it should be understood that the shapes and the like of the components according to both embodiments are basically the same, except for the different components described below.

The damper device 1 according to the sixth embodiment has substantially the same configuration as the damper device 1 according to the embodiment described above, but the configurations of the disc plate 100, the hub 200, the control plate 300, the first sliding portion 600, and the second sliding portion 700 are different from those of the embodiment described above. Note that, as for the damper device 1 according to the sixth embodiment, the same components as those of the damper device 1 according to the above embodiment are not described in detail herein.

Unlike that of the embodiment, the control plate 300 in the damper device 1 according to the sixth embodiment is designed so that the respective axially extending portions 303a to 303d are not accommodated in the grooves 208a to 208d of the hub 200, but are accommodated in the disc plate 100. Specifically, as illustrated in FIG. 14, the first plate 100A of the damper device 1 according to the sixth embodiment has accommodation grooves 130 (accommodation grooves 130a to 130d) that are associated with the respective regions I to IV, and accommodate the axially extending portions 303a to 303d. The accommodation grooves 130a to 130d may be provided integrally on the radially inner side of the first accommodation region 102a, the second accommodation region 102b, the third accommodation region 102c, and the fourth accommodation region 102d formed on the first plate 100A, or may be independently formed on the first plate 100A, as in the case where the grooves 208a to 208d of the embodiment are continuously formed in the window holes 206a to 206d of the hub 200. Note that FIG. 14 illustrates an example in which the accommodation groove 130a is formed independently of the first accommodation region 102a.

In the sixth embodiment, as illustrated in FIG. 14, the axially extending portions 303a to 303d of the control plate 300 are accommodated in gaps of a predetermined distance formed at positions close to wall portions 130w defining the accommodation grooves 130a to 130d. This corresponds to the accommodation of the axially extending portions 303a to 303d at positions close to the wall portions 208w in the embodiment.

On the other hand, the grooves 208a to 208d of the hub 200 in the damper device 1 according to the sixth embodiment can be omitted, because the function of accommodating the axially extending portions 303a to 303d of the control plate 300 is unnecessary. Meanwhile, as illustrated in FIG. 13, an engaging hole 210 with which the second sliding portion 700 is to be engaged is separately formed in the hub 200. With this arrangement, the second sliding portion 700 is engaged with the hub 200 so that the second sliding portion 700 can rotate integrally with the hub 200.

The first sliding portion 600 in the damper device 1 according to the sixth embodiment basically has the same configuration as that of the embodiment, but is disposed at a position close to the rotation axis O.

The damper device 1 according to the sixth embodiment designed as described above basically operates in the same manner as in the embodiment. However, the relationship between the control plate 300 and the hub 200 according to the embodiment described with reference to FIGS. 7A to 7F is replaced with the relationship between the control plate 300 and the disc plate 100 (the first plate 100A) in the sixth embodiment.

Specifically, as in the case illustrated in FIGS. 7B and 7C described above, it is assumed that relative rotation occurs between the disc plate 100 and the hub 200, and a twist of 0° to θ1° to θ2° occurs on the positive side. This case represents a case where the hub 200 relatively rotates (moves) in the R direction (the clockwise direction in FIG. 7B) with respect to the disc plate 100, which is synonymous with a case where the disc plate 100 relatively rotates (moves) in the L direction with respect to the hub 200 when viewed from a different point of view. In this case, in the sixth embodiment, the length of the gaps between the axially extending portions 303a to 303d of the control plate 300 and the wall portions 130w in the corresponding accommodation grooves 130a to 130d become gradually greater, and finally, the axially extending portions 303a to 303d are no longer in contact with the wall portions 130w. Therefore, the control plate 300 is not affected by the relative rotation of the disc plate 100 with respect to the hub 200, and does not rotate relative to the hub 200. On the other hand, the control plate 300 rotates relative to the disc plate 100 (the disc plate 100 rotates relative to the control plate 300). Accordingly, the first sliding torque is generated between the radially extending portions 302 of the control plate 300 and the first sliding surface 602a of the first sliding portion 600.

Next, as in the case illustrated in FIG. 7D described above, it is assumed that relative rotation occurs between the disc plate 100 and the hub 200, and a twist of 0° to θ3° occurs on the negative side. This case represents a case where the hub 200 relatively rotates (moves) in the L direction (the counterclockwise direction in FIG. 7B) with respect to the disc plate 100, which is synonymous with a case where the disc plate 100 relatively rotates (moves) in the R direction with respect to the hub 200 when viewed from a different point of view. In this case, in the sixth embodiment, the length of the gaps between the axially extending portions 303a to 303d of the control plate 300 and the wall portions 130w in the corresponding accommodation grooves 130a to 130d become gradually smaller, and finally, the axially extending portions 303a to 303d come into contact with the wall portions 130w at the twisting angle θ3°. Accordingly, even at the twisting angles of 0° to θ3°, there are gaps between the axially extending portions 303a to 303d and the wall portions 130w. Therefore, the control plate 300 is not affected by the relative rotation of the disc plate 100 with respect to the hub 200, and does not rotate relative to the hub 200. On the other hand, the control plate 300 rotates relative to the disc plate 100 (the disc plate 100 rotates relative to the control plate 300). Accordingly, the first sliding torque is generated between the radially extending portions 302 of the control plate 300 and the first sliding surface 602a of the first sliding portion 600.

Next, as in the case illustrated in FIG. 7E described above, it is assumed that relative rotation occurs between the disc plate 100 and the hub 200, and a twist of θ3° to θ4° occurs on the negative side. This case represents a case where the hub 200 relatively rotates (moves) in the L direction (the counterclockwise direction in FIG. 7B) with respect to the disc plate 100, which is synonymous with a case where the disc plate 100 relatively rotates (moves) in the R direction with respect to the hub 200 when viewed from a different point of view. In this case, in the sixth embodiment, the axially extending portions 303a to 303d of the control plate 300 come into contact with the wall portions 130w in the corresponding accommodation grooves 130a to 130d. Accordingly, the control plate 300 rotates integrally with the disc plate 100. As a result, the control plate 300 rotates relative to the hub 200, and the second sliding torque is generated between the radially extending portions 302a to 302d of the control plate 300 and the second sliding surface 702b of the second sliding portion 700.

In the sixth embodiment unlike the embodiment, the second sliding torque is set to be higher than the first sliding torque.

Further, in the thrust member 500 in the sixth embodiment, the third sliding torque is generated as in the embodiment. Accordingly, in the sixth embodiment, the total torque of the third sliding torque and the first sliding torque is used as a “low hysteresis torque”, and the total torque of the third sliding torque and the second sliding torque is used as a “high hysteresis torque”.

Although not illustrated in FIG. 13, the plate portion 602 can include, on the first sliding surface 602a, a first vertex portion 602a₁ in contact with the radially extending portion 302 of the control plate 300, a first inclined surface 602a₂ connected to the first vertex portion 602a₁, and a second inclined surface 602a₃ connected to the first vertex portion 602a₁, as described above with reference to FIG. 3C.

Further, as described above with reference to FIG. 3B, the gap G₁ formed between the inner peripheral surface surrounding the opening (first opening) 602A formed in the plate portion 602 and the outer peripheral surface of the hub 200 can be smaller than the gap G₂ formed between the inner peripheral surface surrounding the opening (second opening) 500a formed in the thrust member 500 and the outer peripheral surface of the hub 200.

### 3-6. Seventh Embodiment

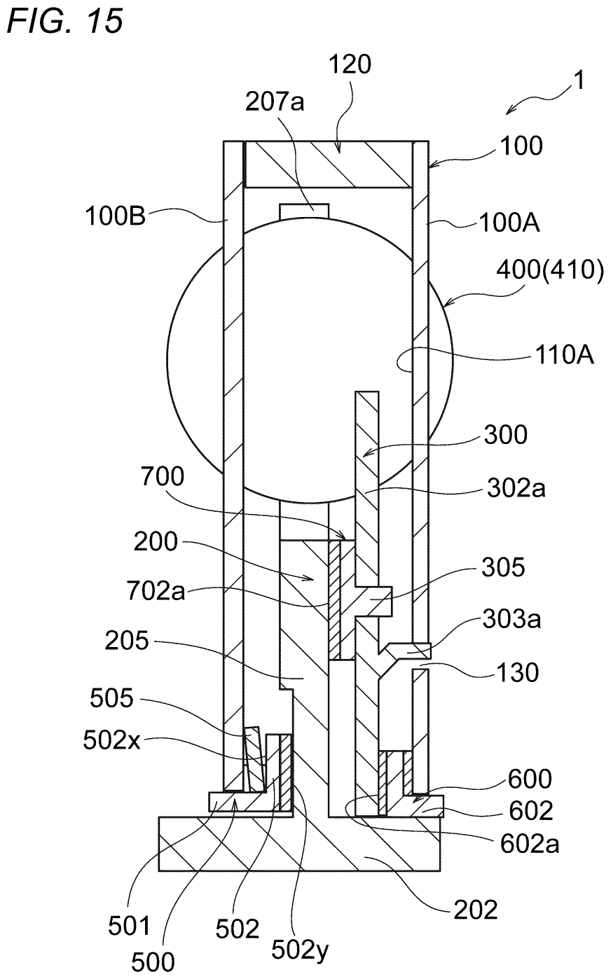

Next, the configuration of a damper device 1 according to a seventh embodiment is described with reference to FIG. 15. FIG. 15 is a schematic cross-sectional view schematically illustrating the configuration of the damper device 1 according to the seventh embodiment. Note that FIG. 15 is a diagram for briefly explaining that the damper device 1 according to the seventh embodiment includes components described below that are different from those of the damper device 1 according to the embodiment, and is a diagram focusing on the portion related to the region I. Therefore, the components common between the damper device 1 according to the embodiment illustrated in FIG. 3A and others, and the damper device 1 according to the seventh embodiment illustrated in FIG. 15 are illustrated as slightly different from each other in FIG. 15 for convenience sake. However, it should be understood that the shapes and the like of the components according to both embodiments are basically the same, except for the different components described below.

The damper device 1 according to the seventh embodiment has substantially the same configuration as the damper device 1 according to the embodiment described above, but the configurations of the disc plate 100, the hub 200, the control plate 300, the thrust member 500, the first sliding portion 600, and the second sliding portion 700 are different from those of the embodiment described above. On the other hand, the damper device 1 according to the seventh embodiment has substantially the same configuration as the damper device 1 according to the sixth embodiment described above. Therefore, as for the damper device 1 according to the seventh embodiment, portions basically different from those of the damper device 1 according to the sixth embodiment are mainly described, and detailed explanation of the other portions is not made herein.

The thrust member 500 in the damper device 1 according to the seventh embodiment has a fourth elastic member 505 as in the second embodiment. With this arrangement, the second surface 502y of the thrust member 500 is pressed against the hub 200 (the disc portion 205) by the biasing force of the fourth elastic member 505, so that the third sliding torque can be reliably and efficiently generated when the disc plate 100 and the hub 200 rotate relative to each other.

Further, as described above in the second embodiment, the reaction force of the biasing force of the fourth elastic member 505 is transmitted to the second plate 100B, so that the first plate 100A is biased in the direction toward the control plate 300 (the leftward direction in the plane of FIG. 15). As a result, the first plate 100A is pressed against the first sliding portion 600, and the control plate 300 is pressed against the first sliding portion 600. That is, the first sliding portion 600 in the seventh embodiment does not include the second elastic member 604. With this arrangement, the first sliding torque can be generated when the control plate 300 and the disc plate 100 rotate relative to each other, between the first plate 100A and the first sliding portion 600 (the first sliding surface 602a), and between the first sliding portion 600 (the first sliding surface 602a) and the radially extending portions 302 of the control plate 300.

Meanwhile, unlike the second sliding portion 700 of the sixth embodiment, the second sliding portion 700 in the damper device 1 according to the seventh embodiment is engaged with the control plate 300 so as to be rotatable integrally with the control plate 300. Specifically, in the seventh embodiment, the second sliding portion 700 is designed to be engaged with (fitted to) an engaging hole 305 formed in the radially extending portion 302 of the control plate 300. With this configuration, when the control plate 300 and the hub 200 rotate relative to each other, the second sliding torque can be generated between the hub 200 (the disc portion 205) and the second sliding surface 702a of the second sliding portion 700, as in the sixth embodiment.

In the seventh embodiment, the second sliding torque is set to be higher than the first sliding torque, as in the sixth embodiment. Further, in the seventh embodiment, the total torque of the third sliding torque and the first sliding torque is used as a “low hysteresis torque”, and the total torque of the third sliding torque and the second sliding torque is used as a “high hysteresis torque”.

Although not illustrated in FIG. 15, the plate portion 602 can include, on the first sliding surface 602a, a first vertex portion 602a₁ in contact with the radially extending portion 302 of the control plate 300, a first inclined surface 602a₂ connected to the first vertex portion 602a₁, and a second inclined surface 602a₃ connected to the first vertex portion 602a₁, as described above with reference to FIG. 3C.

Further, as described above with reference to FIG. 3B, the gap G₁ formed between the inner peripheral surface surrounding the opening (first opening) 602A formed in the plate portion 602 and the outer peripheral surface of the hub 200 can be smaller than the gap G₂ formed between the inner peripheral surface surrounding the opening (second opening) 500a formed in the thrust member 500 and the outer peripheral surface of the hub 200.

### 3-7. Eighth Embodiment

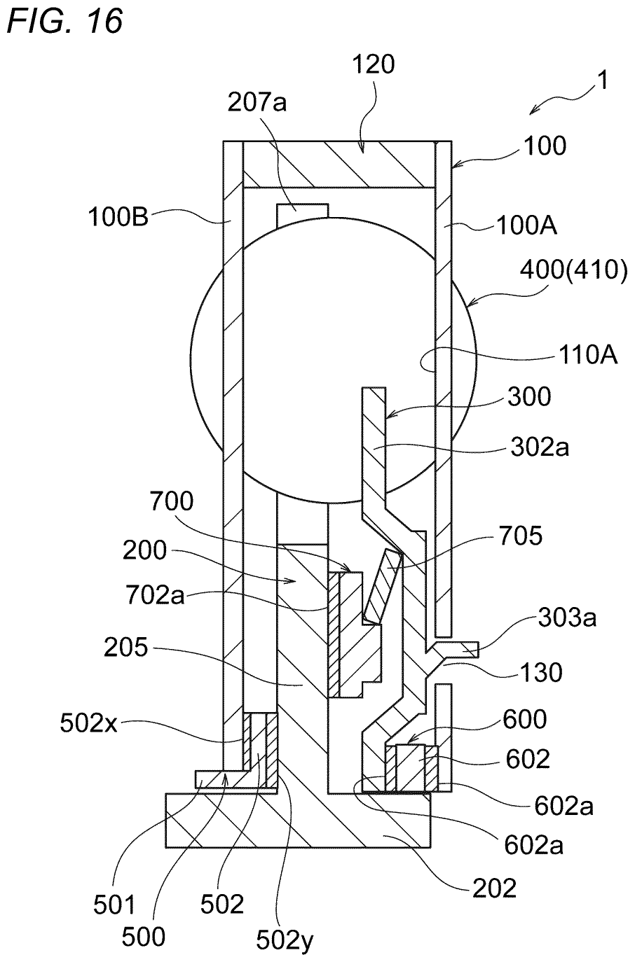

Next, the configuration of a damper device 1 according to an eighth embodiment is described with reference to FIG. 16. FIG. 16 is a schematic cross-sectional view schematically illustrating the configuration of the damper device 1 according to the eighth embodiment. Note that FIG. 16 is a diagram for briefly explaining that the damper device 1 according to the eighth embodiment includes components described below that are different from those of the damper device 1 according to the embodiment, and is a diagram focusing on the portion related to the region I. Therefore, the components common between the damper device 1 according to the embodiment illustrated in FIG. 3A and others, and the damper device 1 according to the eighth embodiment illustrated in FIG. 16 are illustrated as slightly different from each other in FIG. 16 for convenience sake. However, it should be understood that the shapes and the like of the components according to both embodiments are basically the same, except for the different components described below.

The damper device 1 according to the eighth embodiment has substantially the same configuration as the damper device 1 according to the embodiment described above, but the configurations of the disc plate 100, the hub 200, the control plate 300, the first sliding portion 600, and the second sliding portion 700 are different from those of the embodiment described above. On the other hand, the damper device 1 according to the eighth embodiment has substantially the same configuration as the damper device 1 according to the sixth embodiment described above. Therefore, as for the damper device 1 according to the eighth embodiment, portions basically different from those of the damper device 1 according to the sixth embodiment are mainly described, and detailed explanation of the other portions is not made herein.

The second sliding portion 700 in the damper device 1 according to the eighth embodiment has a third elastic member 705 that biases the second sliding surface 702a in the direction to press the second sliding surface 702a against the hub 200 (the disc portion 205) (the leftward direction in the plane of FIG. 16), as in the third embodiment. At this point of time, the second sliding portion 700 can be engaged with the control plate 300. As a result, when the control plate 300 and the hub 200 rotate relative to each other, the second sliding torque can be reliably and efficiently generated between the hub 200 and the second sliding surface 702a.

Meanwhile, the reaction force of the biasing force of the third elastic member 705 is transmitted to the control plate 300, so that the radially extending portion 302 of the control plate 300 is pressed (biased) against the first sliding portion 600. Further, in conjunction with this, the first sliding portion 600 is pressed against the first plate 100A. As a result, the first sliding torque can be generated when the control plate 300 and the disc plate 100 rotate relative to each other, between the radially extending portion 302 of the control plate 300 and the first sliding portion 600 (the first sliding surface 602a), and between the first sliding portion 600 (the first sliding surface 602a) and the inner surface 110A of the first plate 100A.

Further, the first plate 100A is biased in the direction away from the control plate 300 (the rightward direction in the plane of FIG. 16) on the basis of the above-mentioned reaction force, so that the second plate 100B integrated with the first plate 100A via the rivets 120 is biased in the direction toward the hub 200 (the rightward direction in the plane of FIG. 16). As a result, the above-described third sliding torque can be reliably and efficiently generated on the first surface 502x and the second surface 502y of the thrust member 500.

In the eighth embodiment, the second sliding torque is set to be higher than the first sliding torque, as in the sixth embodiment. Further, in the eighth embodiment, the total torque of the third sliding torque and the first sliding torque is used as a “low hysteresis torque”, and the total torque of the third sliding torque and the second sliding torque is used as a “high hysteresis torque”.

Although not illustrated in FIG. 16, the plate portion 602 can include, on the first sliding surface 602a, a first vertex portion 602a₁ in contact with the radially extending portion 302 of the control plate 300, a first inclined surface 602a₂ connected to the first vertex portion 602a₁, and a second inclined surface 602a₃ connected to the first vertex portion 602a₁, as described above with reference to FIG. 3C.

Further, as described above with reference to FIG. 3B, the gap G₁ formed between the inner peripheral surface surrounding the opening (first opening) 602A formed in the plate portion 602 and the outer peripheral surface of the hub 200 can be smaller than the gap G₂ formed between the inner peripheral surface surrounding the opening (second opening) 500a formed in the thrust member 500 and the outer peripheral surface of the hub 200.

### 3-8. Ninth Embodiment

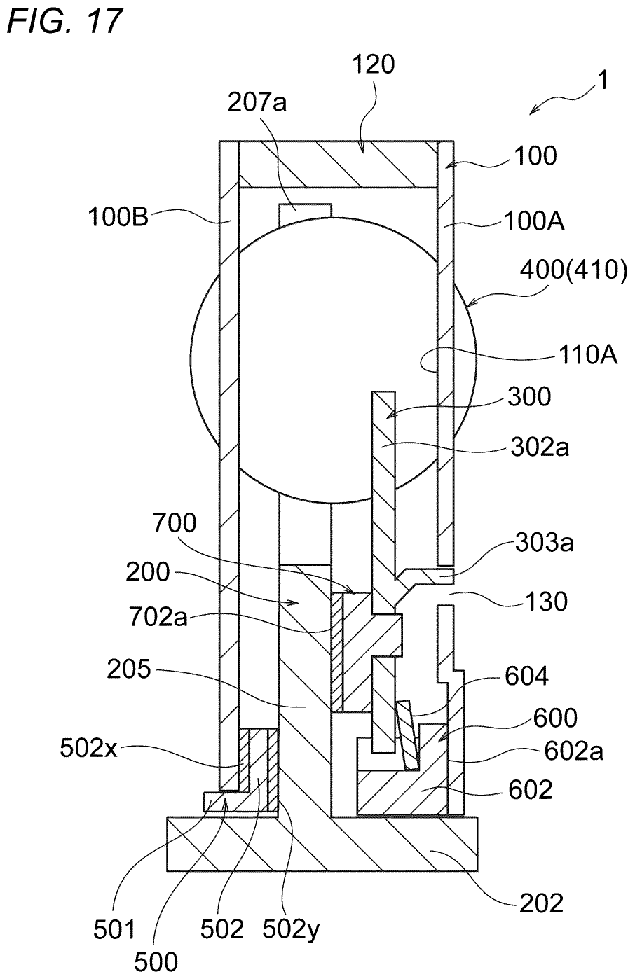

Next, the configuration of a damper device 1 according to a ninth embodiment is described with reference to FIG. 17. FIG. 17 is a schematic cross-sectional view schematically illustrating the configuration of the damper device 1 according to the ninth embodiment. Note that FIG. 17 is a diagram for briefly explaining that the damper device 1 according to the ninth embodiment includes components described below that are different from those of the damper device 1 according to the embodiment, and is a diagram focusing on the portion related to the region I. Therefore, the components common between the damper device 1 according to the embodiment illustrated in FIG. 3A and others, and the damper device 1 according to the ninth embodiment illustrated in FIG. 17 are illustrated as slightly different from each other in FIG. 17 for convenience sake. However, it should be understood that the shapes and the like of the components according to both embodiments are basically the same, except for the different components described below.

The damper device 1 according to the ninth embodiment has substantially the same configuration as the damper device 1 according to the embodiment described above, but the configurations of the disc plate 100, the hub 200, the control plate 300, the first sliding portion 600, and the second sliding portion 700 are different from those of the embodiment described above. On the other hand, the damper device 1 according to the ninth embodiment has substantially the same configuration as the damper device 1 according to the seventh embodiment described above. Therefore, as for the damper device 1 according to the ninth embodiment, portions basically different from those of the damper device 1 according to the seventh embodiment are mainly described, and detailed explanation of the other portions is not made herein.

The first sliding portion 600 in the damper device 1 according to the ninth embodiment includes a second elastic member 604 that biases the first sliding surface 602a in the direction toward the first plate 100A (the rightward direction in the plane of FIG. 17). Also, the first sliding portion 600 of the ninth embodiment can be engaged with the control plate 300, to be rotatable integrally with the control plate 300. With this arrangement, the first sliding torque can be reliably and efficiently generated when the control plate 300 and the disc plate 100 rotate relative to each other.

Further, the first plate 100A is biased in the direction away from the control plate 300 (the rightward direction in the plane of FIG. 17) by the biasing force of the second elastic member 604 described above. Here, the biasing force is also transmitted to the second plate 100B integrated with the first plate 100A via the rivets 120, and therefore, the second plate 100B is biased in the direction toward the hub 200 (the rightward direction in the plane of FIG. 17). As a result, the above-described third sliding torque can be reliably and efficiently generated on the first surface 502x and the second surface 502y of the thrust member 500.

In the ninth embodiment, the second sliding torque is set to be higher than the first sliding torque, as in the sixth embodiment. Further, in the ninth embodiment, the total torque of the third sliding torque and the first sliding torque is used as a “low hysteresis torque”, and the total torque of the third sliding torque and the second sliding torque is used as a “high hysteresis torque”.

Although not illustrated in FIG. 17, the plate portion 602 can include, on the first sliding surface 602a, a first vertex portion 602a₁ in contact with the first plate 100A, a first inclined surface 602a₂ that is connected to the first vertex portion 602a₁, extends in the direction away from the rotation axis O, and is inclined in the direction away from the first plate 100A, and a second inclined surface 602a₃ that is connected to the first vertex portion 602a₁, extends in the direction toward the rotation axis O, and is inclined in the direction away from the first plate 100A, as described above with reference to FIG. 3C.

Further, as described above with reference to FIG. 3B, the gap G₁ formed between the inner peripheral surface surrounding the opening (first opening) 602A formed in the plate portion 602 and the outer peripheral surface of the hub 200 can be smaller than the gap G₂ formed between the inner peripheral surface surrounding the opening (second opening) 500a formed in the thrust member 500 and the outer peripheral surface of the hub 200.

### 3-9. Tenth Embodiment

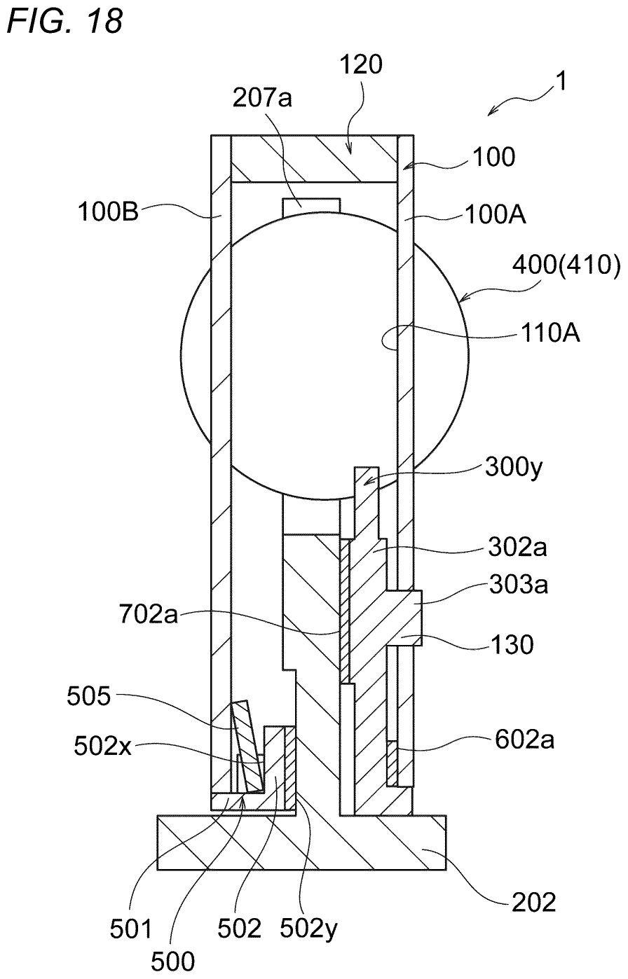

Next, the configuration of a damper device 1 according to a tenth embodiment is described with reference to FIG. 18. FIG. 18 is a schematic cross-sectional view schematically illustrating the configuration of the damper device 1 according to the tenth embodiment. Note that FIG. 18 is a diagram for briefly explaining that the damper device 1 according to the tenth embodiment includes components described below that are different from those of the damper device 1 according to the embodiment, and is a diagram focusing on the portion related to the region I. Therefore, the components common between the damper device 1 according to the embodiment illustrated in FIG. 3A and others, and the damper device 1 according to the tenth embodiment illustrated in FIG. 18 are illustrated as slightly different from each other in FIG. 18 for convenience sake. However, it should be understood that the shapes and the like of the components according to both embodiments are basically the same, except for the different components described below.

Although the damper device 1 according to the tenth embodiment has substantially the same configuration as the seventh embodiment described above, the first sliding portion 600 and the second sliding portion 700 are integrally formed with the control plate 300 as in the fifth embodiment. That is, the control plate 300, the first sliding portion 600, and the second sliding portion 700 are formed as one combined component. The combined component formed in this manner can be regarded as a control plate 300y (for convenience sake, the control plate in the tenth embodiment is referred to as the “control plate 300y”) that has both the functions of the first sliding portion 600 and the functions of the second sliding portion 700 according to the seventh embodiment.

Accordingly, the control plate 300y according to the tenth embodiment can include, on the radially extending portion 302, the first sliding surface 602a that slides directly on the inner surface 110A of the first plate 100A to generate the first sliding torque, and the second sliding surface 702a that slides directly on the hub 200 (the disc portion 205) to generate the second sliding torque. As a result, the damper device 1 according to the tenth embodiment can operate like the damper device 1 according to the seventh embodiment.

In the tenth embodiment, the second sliding torque is set to be higher than the first sliding torque, as in the seventh embodiment. Further, in the tenth embodiment, the total torque of the third sliding torque and the first sliding torque is used as a “low hysteresis torque”, and the total torque of the third sliding torque and the second sliding torque is used as a “high hysteresis torque”.

Although not illustrated in FIG. 18, the control plate 300y can include, on the first sliding surface 602a, a first vertex portion 602a₁ in contact with the first plate 100A, a first inclined surface 602a₂ that is connected to the first vertex portion 602a₁, extends in the direction away from the rotation axis O, and is inclined in the direction away from the first plate 100A, and a second inclined surface 602a₃ that is connected to the first vertex portion 602a₁, extends in the direction toward the rotation axis O, and is inclined in the direction away from the first plate 100A, as described above with reference to FIG. 3C.

Further, as described above with reference to FIG. 3B, the gap G₁ formed between the inner peripheral surface surrounding the opening (first opening) 602A formed in the control plate 300x and the outer peripheral surface of the hub 200 can be smaller than the gap G₂ formed between the inner peripheral surface surrounding the opening (second opening) 500a formed in the thrust member 500 and the outer peripheral surface of the hub 200.

### 3-10. Others

In the various embodiments described above, the first sliding portion 600 and the like can include, on the first sliding surface 602a, the first vertex portion 602a₁ in contact with the radially extending portions 302 (or the first plate 100A and the like) of the control plate 300, the first inclined surface 602a₂ connected to the first vertex portion 602a₁, and the second inclined surface 602a₃ connected to the first vertex portion 602a₁. Additionally or alternatively, the thrust member 500 and/or the second sliding portion 700 may include components similar to the above.

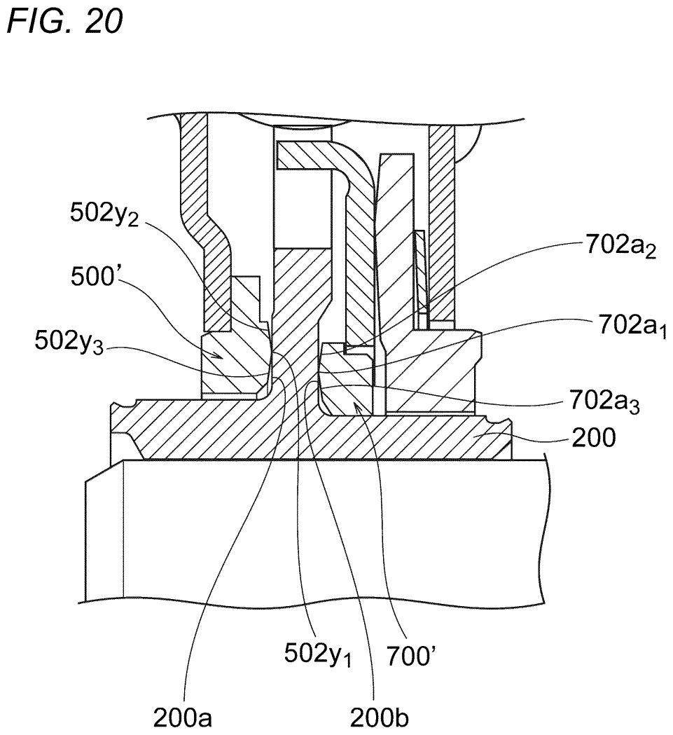

A specific example thereof is now described with reference to FIGS. 19 and 20. FIG. 19 is a schematic cross-sectional view schematically illustrating the configuration of a damper device according to an embodiment. FIG. 20 is a schematic enlarged cross-sectional view schematically illustrating part of the configuration of the damper device illustrated in FIG. 19.

A component formed by modifying the configuration of part of the thrust member 500 described with reference to FIG. 3A and others is illustrated as a thrust member 500′ in FIGS. 19 and 20, and a component formed by modifying the configuration of part of the second sliding member 700 described with reference to FIG. 3A and others is illustrated as a second sliding member 700′ in FIGS. 19 and 20. The input shaft S of the transmission (not illustrated) rotatably supported by the bearing B is inserted into (the through hole 203 [see FIG. 3A] formed in the cylindrical portion 202 of) the hub 200.

As described above, in a case where there is a deviation between the center of rotation of the drive shaft Z (or the disc plate 100) and the center of rotation of the input shaft S of the transmission, the rotation axis of the hub 200 through which the input shaft S is inserted is inclined with respect to the drive shaft Z (or the disc plate 100). As a result, the thrust member 500 and the second sliding portion 700 supported by the hub 200 are inclined with respect to the drive shaft Z, or with respect to the flywheel 2 and the disc plate 100 connected to the flywheel 2. In this case, there is a possibility that the second surface 502y of the thrust member 500 and the second sliding surface 702a of the second sliding portion 700 do not slide on the hub 200 as originally intended.

Therefore, as illustrated in detail in FIG. 20, the thrust member 500′ can include, on a second surface 500y, a second vertex portion 502y₁ in contact with the hub 200 (a surface 200a facing the thrust member 500′), a third inclined surface 502y₂ connected to the second vertex portion 502y₁, and a fourth inclined surface 502y₃ connected to the second vertex portion 502y₁. The third inclined surface 502y₂ can extend in the direction (the upward direction in FIG. 20) away from the rotation axis (which is the rotation axis O) of the thrust member 500 with reference to the second vertex portion 502y₁, and be inclined in the direction (the leftward direction in FIG. 20) away from the surface 200a of the hub 200. The fourth inclined surface 502y₃ can extend in the direction (the downward direction in FIG. 20) toward the rotation axis (which is the rotation axis O) of the thrust member 500 with reference to the second vertex portion 502y₁, and be inclined in the direction (the leftward direction in FIG. 20) away from the surface 200a of the hub 200. With this arrangement, the thrust member 500′ can slide while being in contact with the surface 200a of the hub 200 at the second vertex portion 502y₁.

As a result, even in a case where the hub 200 is inclined with respect to the drive shaft Z, the thrust member 500′ still slides while being in contact with the surface 200a of the hub 200 at the second vertex portion 502y₁, so that the area of the portion of contact between the thrust member 500′ and the hub 200 does not change significantly. As a result, the magnitude of the third sliding torque is prevented from changing.

Meanwhile, as illustrated in detail in FIG. 20, the second sliding portion 700′ can include, on the second sliding surface 702a, a third vertex portion 702a₁ in contact with the hub 200 (a surface 200b facing the second sliding portion 700′), a fifth inclined surface 702a₂ connected to the third vertex portion 702a₁, and a sixth inclined surface 702a₃ connected to the third vertex portion 702a₁. The fifth inclined surface 702a₂ can extend in the direction (the upward direction in FIG. 20) away from the rotation axis (which is the rotation axis O) of the second sliding portion 700′ with reference to the third vertex portion 702a₁, and be inclined in the direction (the rightward direction in FIG. 20) away from the surface 200b of the hub 200. The sixth inclined surface 702a₃ can extend in the direction (the downward direction in FIG. 20) toward the rotation axis (which is the rotation axis O) of the second sliding portion 700′ with reference to the third vertex portion 702a₁, and be inclined in the direction (the rightward direction in FIG. 20) away from the surface 200b of the hub 200. With this arrangement, the second sliding portion 700′ can slide while being in contact with the surface 200b of the hub 200 at the third vertex portion 702a₁.

Therefore, even in a case where the hub 200 is inclined with respect to the drive shaft Z, the second sliding portion 700′ still slides while being in contact with the surface 200b of the hub 200 at the third vertex portion 702a₁, so that the area of the portion of contact between the second sliding portion 700′ and the hub 200 does not change significantly. As a result, the magnitude of the second sliding torque is prevented from changing.

Further, in all the embodiments described above, an example in which the control plate 300 is accommodated in the first accommodation space 100x has been described in detail. However, as described above, the control plate 300 may be accommodated in the second accommodation space 100y. In this case, in all the embodiments, the components disposed in the first accommodation space 100x and the components disposed in the second accommodation space 100y may be interchanged with each other.

A specific example thereof is now briefly described with reference to FIG. 21. FIG. 21 is a schematic cross-sectional view schematically illustrating the configuration of a damper device according to an embodiment. Referring to FIG. 21 compared with FIG. 3A referred to earlier, a first sliding portion 600R illustrated in FIG. 21 can have a cross-sectional shape in which the first sliding portion 600 is inverted (mirrored) so as to have a bilaterally symmetrical relationship with the first sliding portion 600 illustrated in FIG. 3A. Likewise, a thrust member 500R and a second sliding portion 700R illustrated in FIG. 21 can have a cross-sectional shape obtained by inverting (mirroring) the thrust member 500 and the second sliding portion 700 so as to have a bilaterally symmetrical relationship with the thrust member 500 and the second sliding portion 700 illustrated in FIG. 3A, respectively. The same applies to the control plate 300 illustrated in FIG. 3A.

Further, in a case where such a configuration is adopted, the gap formed between the inner peripheral surface surrounding the opening (second opening) 500a formed in the thrust member 500R (disposed closer to a bearing S or the transmission) and the outer peripheral surface of a hub 200R can be narrower than the gap formed between the inner peripheral surface surrounding the opening (first opening 602A) formed in the first sliding portion 600R (disposed farther from the bearing S or the transmission) and the outer peripheral surface of the hub 200R. With this arrangement, the angle at which the hub 200R is inclined with respect to the drive shaft Z, which is the angle at which the thrust member 500R supported by the hub 200R is inclined, can be restricted to a small angle.

Furthermore, referring to FIGS. 7A to 7F, in the various embodiments described above, the damper device 1 has torsion characteristics as illustrated in FIG. 8, by adopting a configuration in which the radially extending portions 302 of the control plate 300 are engaged with the elastic mechanical units 400 or the sheets 410, and the axially extending portions 303 of the control plate 300 are engaged with the wall portions 208 of the hub 200.

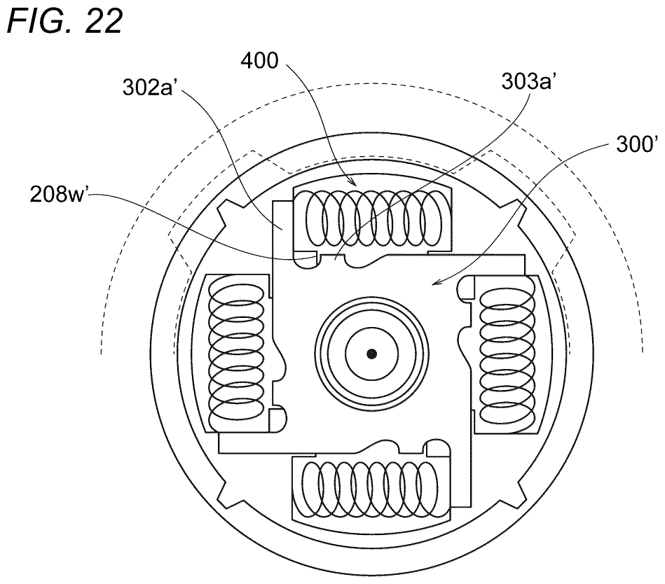

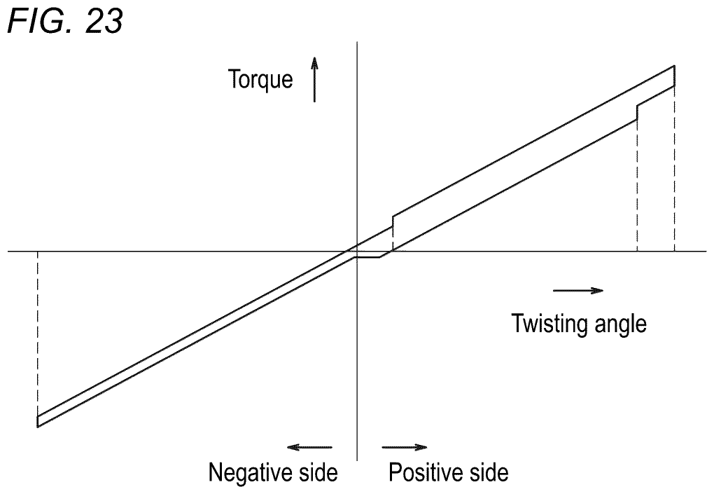

In this regard, it is also possible to adopt a configuration in which the layout of the radially extending portions 302 and the axially extending portions 303 of the control plate 300, and the wall portions 208w of the hub 200 illustrated in FIG. 7A and others is reversed so as to be bilaterally symmetrical. For example, as illustrated in FIG. 22, a control panel 300′ can have a shape obtained by inverting (mirroring) the control panel 300 so as to have a bilaterally symmetrical relationship with the control panel 300 illustrated in FIG. 7A. Likewise, the positions of the four wall portions 208w of the hub 200 illustrated in FIG. 7A can be reversed (mirrored), to provide four wall portions 208w′ in the hub 200 as illustrated in FIG. 22. By adopting such a configuration, the damper device 1 can have torsion characteristics as illustrated in FIG. 23.

The torsion characteristics illustrated in FIG. 23 are now described while being compared with the torsion characteristics illustrated in FIG. 8. In the damper device 1 illustrated in FIG. 7A and others, as described above with reference to FIG. 7E, in a case where the hub 200 rotates relative to the disc plate 100 on the negative side, or in the L direction (the counterclockwise direction in FIG. 7A and others), the axially extending portions 303 of the control plate 300 and the wall portions 208w of the hub 200 come into contact with each other, so that the hub 200 and the control plate 300 rotate integrally. Accordingly, the first sliding torque (higher than the second sliding torque) is generated between the first sliding surface 602a of the first sliding portion 600 and the radially extending portions 302 of the control plate 300. As a result, from the state illustrated in FIG. 7D to the state illustrated in FIG. 7E, a “high hysteresis torque” that is the sum of the first sliding torque and the third sliding torque is generated. Accordingly, in a case where the hub 200 rotates relatively on the negative side with respect to the disc plate 100, as illustrated in FIG. 8, the damper device 1 can generate a “high hysteresis torque”.

In the damper device 1 illustrated in FIG. 22, on the other hand, in a case where the hub 200 rotates relative to the disc plate 100 on the positive side, or in the R direction (the clockwise direction in FIG. 22), axially extending portions 303′ (an axially extending portion 303a′, for example) of the control plate 300′ and the wall portions 208w′ of the hub 200 come into contact with each other, so that the hub 200 and the control plate 300′ rotate integrally. Accordingly, the first sliding torque (higher than the second sliding torque) is generated between the first sliding surface 602a of the first sliding portion 600 and the radially extending portions 302 (a radially extending portion 302a′, for example) of the control plate 300′. As a result, a “high hysteresis torque” that is the sum of the first sliding torque and the third sliding torque is generated. Accordingly, in a case where the hub 200 rotates relatively on the positive side with respect to the disc plate 100, as illustrated in FIG. 23, the damper device 1 can generate a “high hysteresis torque”.

As described above, the damper device 1 illustrated in FIG. 22 can have the torsion characteristics illustrated in FIG. 23, in which the positive side and the negative side are reversed compared with the torsion characteristics of the damper device 1 illustrated in FIG. 7A and others, or the direction in which the hub 200 relatively rotates with respect to the disc plate 100 is reversed.

As is easily understood by those skilled in the art having the benefit of this disclosure, the various examples described above may be used in appropriate combinations in various patterns as long as no contradictions arise.

As described above, various embodiments have been described. However, the above embodiments are merely examples, and are not intended to limit the scope of the invention. The above embodiments can be implemented in various other modes, and various omissions, replacements, and changes can be made to them, without departing from the spirit of the disclosure. Further, the respective components, shapes, sizes, lengths, widths, thicknesses, heights, numbers, and the like can be changed as appropriate before implementation. The various embodiments described above can also be applied to damper devices for applications that do not require the limiter function described above, such as a clutch disc, for example. This application is based on and claims the benefit of priority from Japanese Patent Application No. 2022-059089, filed on Mar. 31, 2022, and entitled “DAMPER DEVICE”. The entire contents of this Japanese patent application are incorporated herein by reference.

### REFERENCE SIGNS LIST

1: Damper device, 100: First rotating body (disc plate), 100A: First plate, 100B: Second plate, 100x: First accommodation space, 100y: Second accommodation space, 200: Second rotating body (hub), 202: Cylindrical portion, 205: Disc portion, 206a to 206d: Window hole, 208a to 208d: Groove, 208w: Wall portion, 300: Control plate, 302a to 302d: Radially extending portion, 303a to 303d: Axially extending portion, 400: Elastic mechanical unit, 410: First elastic member, 420: Pair of sheet members, 420A, 420B: Sheet member, 500: Thrust member, 500a: Second opening, 502x: First surface, 502y: Second surface, 502y₁: Second vertex portion, 502y₂: Third inclined surface, 502y₃: Fourth inclined surface, 505: Fourth elastic member, 600: First sliding portion, 602a: First sliding surface, 602a₁: First vertex portion, 602a₂: First inclined surface, 602a₃: Second inclined surface, 602A: First opening, 602B: First engaging portion, 602C: Second engaging portion, 604: Second clastic member, 700: Second sliding portion, 702a: Second sliding surface, 702a₁: Third vertex portion, 702a₂: Fifth inclined surface, 702a₃: Sixth inclined surface, 705: Third elastic member, and O: Rotation axis

1. A damper device comprising:
a first rotating body including at least a first plate that rotates about a rotation axis, and a second plate that is disposed to face the first plate and rotates integrally with the first plate about the rotation axis;
a second rotating body that rotates relative to the first rotating body about the rotation axis;
an elastic mechanical unit that elastically connects the first rotating body and the second rotating body in a rotation direction;
a control plate including a radially extending portion that extends in a radial direction and is in contact with the elastic mechanical unit, and an axially extending portion that extends in an axial direction and is at least partially accommodated in one of the first rotating body or the second rotating body, the control plate being disposed only in one of a first accommodation space between the first plate and the second rotating body or a second accommodation space between the second plate and the second rotating body in the axial direction;
a first sliding portion that is disposed between the first rotating body and the control plate, slides with respect to at least one of the first rotating body or the control plate to generate a first sliding torque, has a first opening, and is rotatably supported by an outer peripheral surface of the second rotating body on an inner peripheral surface surrounding the first opening; and
a second sliding portion that is disposed between the second rotating body and the control plate, and slides with respect to at least one of the second rotating body or the control plate to generate a second sliding torque,
wherein, when the first rotating body and the second rotating body rotate relative to each other, the first sliding torque and the second sliding torque are generated.

2. The damper device according to claim 1, further comprising a thrust member including at least one of a first surface that slides with respect to the first rotating body or a second surface that slides with respect to the second rotating body, in a space on a different side from a space in which the control plate is disposed in the first accommodation space or the second accommodation space.

3. The damper device according to claim 2, wherein the thrust member includes a fourth elastic member that biases the second surface in a direction toward the second rotating body.

4. The damper device according to claim 2, wherein
the thrust member has a second opening, and is rotatably supported by the outer peripheral surface of the second rotating body on an inner peripheral surface surrounding the second opening, and
a gap formed between the inner peripheral surface surrounding one of the first opening or the second opening located on a transmission side and the outer peripheral surface of the second rotating body is narrower than a gap formed between the inner peripheral surface surrounding the other one of the first opening or the second opening and the outer peripheral surface of the second rotating body.

5. The damper device according to claim 1, further comprising
a thrust member including at least one of a first surface that slides with respect to the first rotating body or a second surface that slides with respect to the second rotating body, in a space on a different side from a space in which the control plate is disposed in the first accommodation space or the second accommodation space,
wherein one of the first sliding portion or the thrust member, whichever is located on a transmission side, is formed as a bush.

6. The damper device according to claim 1, wherein,
at a position facing the control plate, the first sliding portion includes:
a first vertex portion in contact with the control plate;
a first inclined surface that is connected to the first vertex portion, extends in a direction away from a rotation axis of the first sliding portion, and is inclined in a direction away from the control plate; and
a second inclined surface that is connected to the first vertex portion, extends in a direction toward the rotation axis, and is inclined in the direction away from the control plate.

7. The damper device according to claim 2, wherein,
at a position facing the second rotating body, the thrust member includes:
a second vertex portion in contact with the second rotating body;
a third inclined surface that is connected to the second vertex portion, extends in a direction away from a rotation axis of the thrust member, and is inclined in a direction away from the second rotating body; and
a fourth inclined surface that is connected to the second vertex portion, extends in a direction toward the rotation axis of the thrust member, and is inclined in the direction away from the second rotating body.

8. The damper device according to claim 1, wherein,
at a position facing the second rotating body, the second sliding portion includes:
a third vertex portion in contact with the second rotating body;
a fifth inclined surface that is connected to the third vertex portion, extends in a direction away from a rotation axis of the second sliding portion, and is inclined in a direction away from the second rotating body; and
a sixth inclined surface that is connected to the third vertex portion, extends in a direction toward the rotation axis of the second sliding portion, and is inclined in the direction away from the second rotating body.

9. The damper device according to claim 1, wherein one of the first sliding torque or the second sliding torque is higher than the other one of the first sliding torque or the second sliding torque, and is generated when the second rotating body rotates relative to the first rotating body in a counterclockwise direction.

10. The damper device according to claim 1, wherein
the elastic mechanical unit includes a first elastic member, and a pair of sheet members that sandwich and support the first elastic member from both sides, and
the radially extending portion is in contact with one of the first elastic member or the pair of sheet members.

11. The damper device according to claim 1, wherein the first sliding portion includes a first sliding surface that slides with respect to the first rotating body or the radially extending portion, and a second elastic member that biases the first sliding surface in a direction toward the first rotating body or the radially extending portion.

12. The damper device according to claim 1, wherein the second sliding portion includes a second sliding surface that slides with respect to the second rotating body or the radially extending portion, and a third elastic member that biases the second sliding surface in a direction toward the second rotating body or the radially extending portion.

13. The damper device according to claim 1, wherein
the first sliding portion and the second sliding portion are formed integrally with the control plate, and function as part of the control plate, and
the radially extending portion slides directly on the first rotating body, and slides directly on the second rotating body.
